(19) United States
(12) Patent Application Publication
(10) Pub. No.: US 2024/0382367 A1
(43) Pub. Date: Nov. 21, 2024

(54) LOWER BODY EXOSKELETON WITH A LINEAR ACTUATOR

(71) Applicant: VIRGINIA TECH INTELLECTUAL PROPERTIES, INC., Blacksburg, VA (US)

(72) Inventor: Alan Asbeck, Blacksburg, VA (US)

(21) Appl. No.: 18/669,021

(22) Filed: May 20, 2024

Related U.S. Application Data
(60) Provisional application No. 63/503,246, filed on May 19, 2023.

(51) Int. Cl. A61H 3/00; A61H 1/02; B25J 9/00

(52) U.S. Cl. CPC A61H 3/00; A61H 1/0262; B25J 9/0006; A61H 2003/007; A61H 2201/123; A61H 2201/163; A61H 2201/1642

(57) ABSTRACT

Embodiments of lower body exoskeletons having linear actuators are described. In one example, an exoskeleton includes an upper juncture assembly for positioning at least partly around a waist of a user. The exoskeleton further includes a linear actuator having a first end and a second end opposite the first end. The first end of the linear actuator is coupled to the upper juncture assembly. The exoskeleton further includes a lower juncture assembly coupled to the second end of the linear actuator. The lower juncture assembly is configured for positioning the second end of the linear actuator at a side of a foot of the user. The exoskeleton further includes a foot attachment interface for positioning at least partly around the foot of the user.

### CROSS REFERENCE TO RELATED APPLICATIONS

This application claims the benefit of and priority to U.S. Provisional Application Ser. No. 63/503,246, filed May 19, 2023, titled “LOWER BODY EXOSKELETON” the entire contents of which are hereby incorporated herein by reference.

### GOVERNMENT LICENSE RIGHTS

This invention was made with government support under grant number 2145085 awarded by the National Science Foundation (NSF). The government has certain rights in the invention.

### BACKGROUND

For applications such as assisting unloaded or loaded walking, lower body exoskeletons can offset the body's weight and can create forces that make locomotion easier. In the biological human body, each of the torques at the individual joints act in concert to create a net force between the ground and the body's center of mass, which is located approximately at the height of the waist. Many traditional lower body exoskeletons have individual motors located at the hip, knee, and ankle to provide a fine degree of control over the individual joints in a user's leg. These exoskeletons also have links between the motors that are used to control the movements of the exoskeleton and the joints in a user's leg when assisting the user with unloaded or loaded walking.

### SUMMARY

The present disclosure is directed to various exoskeleton embodiments that can each create forces on a user's body relative to the ground in a manner that allows for easier locomotion and a gait that more closely mimics a biological gait of a user compared to existing exoskeletons. Some exoskeleton embodiments include a single linear actuator that extends directly to the ground from a location that is adjacent a user's center of mass. A lower end of the linear actuator can be constrained to a position proximate the user's foot in many examples. For instance, a guide tube connector coupled to the user's shoe or foot can be used to constrain the lower end of the linear actuator to a position proximate the user's shoe or foot in some embodiments. In other embodiments, a rocker-bar connector coupled to the wearer's shoe or foot can be used to constrain the lower end of the linear actuator to a position proximate the user's shoe or foot. Various other exoskeleton embodiments include other component configurations for coupling a linear actuator to a user's shoe or foot. All the embodiments overcome disruptions to a user's gait that occur with existing exoskeletons that are connected to a single location on a user's shoe or foot, as well as other disruptions to the user's gait that occur in other types of existing exoskeletons.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, an exoskeleton includes an upper juncture assembly for positioning at least partly around a waist of a user. The exoskeleton further includes a linear actuator having a first end and a second end opposite the first end. The first end of the linear actuator is coupled to the upper juncture assembly. The exoskeleton further includes a lower juncture assembly coupled to the second end of the linear actuator. The lower juncture assembly is configured for positioning the second end of the linear actuator at a side of a foot of the user. The exoskeleton further includes a foot attachment interface for positioning at least partly around the foot of the user.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIGS. 1, 2, 3, 4, 5, and 6 illustrate side views of example exoskeletons according to various aspects and embodiments of the present disclosure.

FIG. 7A illustrates a perspective view of another example exoskeleton according to various aspects and embodiments of the present disclosure.

FIG. 7B illustrates a top view of the example exoskeleton of FIG. 7A according to various aspects and embodiments of the present disclosure.

FIG. 8 illustrates a back view of another example exoskeleton according to various aspects and embodiments of the present disclosure.

FIGS. 9A, 9B, 9C, 9D, and 9E illustrate perspective views example exoskeleton lower ends according to various aspects and embodiments of the present disclosure.

FIG. 9F illustrates a perspective view of another example exoskeleton lower end according to various aspects and embodiments of the present disclosure.

FIG. 9G illustrates a front view of the example exoskeleton lower end of FIG. 9F according to various aspects and embodiments of the present disclosure.

FIGS. 9H, 9I, 9J, 9K, 9L, and 9M illustrate perspective views other example exoskeleton lower ends according to various aspects and embodiments of the present disclosure.

FIG. 10A illustrates a perspective side view of another example exoskeleton lower end according to various aspects and embodiments of the present disclosure.

FIG. 10B illustrates a perspective front view of the example exoskeleton lower end of FIG. 10A according to various aspects and embodiments of the present disclosure.

FIG. 11A illustrates a perspective view of another example exoskeleton according to various aspects and embodiments of the present disclosure.

FIG. 11B illustrates a side view of an example exoskeleton lower end of the example exoskeleton of FIG. 11A according to various aspects and embodiments of the present disclosure.

FIG. 12A illustrates a side view of another example exoskeleton according to various aspects and embodiments of the present disclosure.

FIG. 12B illustrates another side view of the example exoskeleton of FIG. 12A with covers included according to various aspects and embodiments of the present disclosure.

FIG. 13 illustrates a perspective view of another example exoskeleton according to various aspects and embodiments of the present disclosure.

### DETAILED DESCRIPTION

As noted above, for applications such as assisting unloaded or loaded walking, lower body exoskeletons can offset the body's weight and can create forces that make locomotion easier. In the biological human body, each of the torques at the individual joints act in concert to create a net force between the ground and the body's center of mass, which is located approximately at the height of the waist. Many traditional lower body exoskeletons have individual motors at the hip, knee, and ankle. A problem with such lower body exoskeletons is that while they provide a fine degree of control over the individual joints in the leg, they require a significant amount of mass for the motors and links between them, which also makes control of the exoskeleton complex.

Several previous works have proposed exoskeletons that include: a single actuator (e.g., either a linear actuator or one with a hinge joint at approximately the biological knee) connected from the waist to a point on a wearer's foot. A problem with these exoskeletons is that while they create a single force at the waist that may be somewhat close to the body's biological force from the leg, this single force itself is not sufficient for allowing natural walking. For instance, as the lower end of these exoskeletons is terminated at a fixed location on the shoe, the forces are transferred through a bracket on the sides of the shoe to the ground or through the shoe heel to the ground. However, this structure cannot duplicate the biological gait, and restricts the wearer's motion through the application of unwanted forces at different points in the gait cycle.

Specifically, the normal gait cycle consists of the motion of a leg and foot from one heel strike to another, and ranges from 0-100%. In normal walking, the heel contacts the ground at 0% in the gait cycle, and then the foot falls to be flat on the ground starting at around 12% in the gait cycle. After around 30% in the gait cycle, the heel lifts up from the ground, so that only the forefoot is in contact with the ground. The foot then continues to rotate forward until it lifts off the ground at around 62% in the gait cycle.

Some existing exoskeletons are connected to a shoe, and thus transfer the force to the shoe which then transfers the force to the ground. A problem with these exoskeletons is that they only provide a force at a single point on a shoe worn by a user of such exoskeletons. If, for example, an exoskeleton is attached above the ball of the foot, then the exoskeleton will provide forces pushing the foot down onto the floor if it applies force at 0% in the gait cycle. Thus, in this case, the exoskeleton is not able to support bodyweight for the full gait cycle, and it will create an ankle moment that is different than the biological ankle moment. For example, in the first 12% of the gait cycle, the actuator of the exoskeleton cannot apply force if the normal ankle biomechanics are to be preserved: the shin muscles of a wearer must contract and resist the force from the actuator. Conversely, if the shin muscles do not contract and the linear actuator pushes the foot onto the ground, there is still a period of time as the forefoot is falling downward when the linear actuator cannot apply significant forces. During this time, the knee and hip joints of the wearer experience significant torques that prevent the wearer's leg from collapsing (e.g., falling to the ground), but these are not able to be supplemented by the actuator (e.g., neither the exoskeleton nor the actuator provide supportive forces for the leg of the wearer). Additionally, if the exoskeleton control system has errors and creates forces pushing the foot down after the user attempts to lift their foot, then this is severely disruptive to the wearer's gait since the wearer must resist the actuator. This will cause additional exertion for the wearer or possibly even stumbles and falls.

Other existing exoskeletons are attached at the heel of a wearer's foot. A problem with these exoskeletons is that when the heel lifts up at around 30% in the gait cycle, the exoskeleton will push it back down to the ground, severely disrupting the normal biomechanics of walking. For the heel to lift up in these exoskeletons, either the actuator must apply zero force, or the wearer must resist the actuator's force by contracting their calf muscles. If the heel remains on the ground, the ankle and knee are not able to function as they normally do during walking.

A common problem across the aforementioned existing exoskeletons is that they connect to a foot of a wearer at a single, fixed location. However, for an exoskeleton to provide supportive forces on a user's body throughout the entire time their foot is on the ground, it is challenging if not impossible for an exoskeleton to connect to the foot at a single, fixed point.

The present disclosure provides solutions to address problems associated with exoskeletons in general, as well as problems associated with the existing exoskeletons described above. To overcome such limitations, examples of the present disclosure include exoskeletons that can each create forces on a user's body relative to the ground in a manner that allows for easier locomotion and a gait that more closely mimics a biological gait of a user compared to existing exoskeletons. Some exoskeleton embodiments include a single actuator that extends from a location that is close to a user's center of mass to the ground directly. A lower end of the linear actuator can be constrained to a position proximate the user's foot with a guide tube connector coupled to the wearer's shoe or foot in some embodiments or with a rocker-bar connector coupled to the wearer's shoe or foot in other embodiments. Various exoskeleton embodiments include other component configurations for coupling a linear actuator to a user's shoe or foot. All the embodiments overcome disruptions to a user's gait that occur with existing exoskeletons that are connected to a single location on a user's shoe or foot, as well as other disruptions to the user's gait that occur in other types of existing exoskeletons.

Instead of using individual joints and actuators, the embodiments described herein include exoskeletons having a single actuator that creates a force between the ground and a body's center of mass (e.g., a user's center of mass). To accomplish this, some embodiments include only a single actuator (e.g., prismatic actuator) that extends, contracts, or extends and contracts. Unpowered joints are included in some embodiments at a waist region of a wearer to transfer the force to the body's center of mass while permitting free motion in the sagittal and frontal planes and allowing for rotation of a hip and/or ankle of a user. The embodiments are drastically simpler and lighter than exoskeletons with joints at each of the biological joints in the lower body, as well as exoskeletons with joints at the hip and knee.

In one example, an exoskeleton includes a linear actuator coupled to a track that runs fore-aft along a user's foot (e.g., along a path between the toes and heel). The track in this example allows the end of the linear actuator to move forward or backward along the track and the foot depending on where the force should be applied. During heel strike, the linear actuator in this example can be located near the heel of the foot, while after 30% in the gait cycle the linear actuator can be located near the forefoot. In some cases, the linear actuator can move back and forth along the track by itself as the angle of the actuator changes during the gait cycle (e.g., due to the upper end of the linear actuator being connected to the waist region, which moves forward relative to the foot while the foot is on the ground). In some embodiments, the motion of the lower end of the linear actuator can be modulated by springs or dampers in the track to allow the lower end to move at a controllable velocity as the gait cycle progresses. In other embodiments, an additional and smaller actuator can be mounted next to the track and can push the lower end of the linear actuator back and forth along the track depending on where the body is in the gait cycle. In still other embodiments, the track could be curved upward (e.g., with the lowest point near the center or ball of the foot) to help the linear actuator move to the appropriate spot along the foot as a function of the gait cycle. One embodiment includes a ball joint that couples the linear actuator to a sliding carriage on the track. The ball joint allows the foot to rotate relative to the linear actuator. This embodiment is effective although may result in extra mass near the foot for the track and/or actuator.

As an alternative to having a sliding track on the foot, some embodiments include an exoskeleton having a lower end of a linear actuator that contacts the ground directly, using a tube or a rocker bar to constrain the lower end of the linear actuator to the foot. In these embodiments, the lower end of the linear actuator can extend past a wearer's foot to contact the ground at a lower point than the wearer's foot. In some cases, the end of the linear actuator can be a small cylinder or have an elongated curved shape similar to a foot. Both of these options and several variations are described herein and illustrated in the figures. Embodiments herein that include an exoskeleton linear actuator that contacts the ground directly provide a solution to the problem of applying beneficial ground reaction forces that are symmetric with respect to the body's forward motion, and which can allow for a natural gait without providing unwanted forces to the ankle.

The embodiments herein include an exoskeleton device that can provide forces that pass through the body's center of mass in some examples or through a worn backpack or upper body load in other examples, while allowing the force to be applied throughout the entire gait cycle and which does not create counterproductive moments on the ankle during the walking cycle. To accomplish this, various embodiments include an exoskeleton having linkages that can provide a force passing through or close to the center of the body. In some embodiments, the exoskeleton can create a force alongside the foot, not a force connected directly to the wearer's foot or shoe. In some embodiments, the exoskeleton can extend below a wearer's foot. For the forces to follow the direction of the biological ground reaction force, various embodiments include a linear actuator that can achieve these forces.

With multiple joints (e.g., at the hip and knee, or even a single powered joint at the knee), the orientation of an exoskeleton near the ground will change as the user walks or as they squat down. With a knee joint, it is challenging if not impossible for an exoskeleton to stay aligned with the biological knee due to the motion of the ankle and consequent plantarflexion/dorsiflexion of the foot. Some embodiments provide a solution to this problem by having a linear actuator or mechanism that extends in length while keeping substantially the same orientation of the bottom of the mechanism. In these embodiments, the linear actuator can maintain the orientation of the exoskeleton near the foot in a direction that points close to the biological center of mass. These embodiments include a simplified design of the exoskeleton's shape where it contacts the ground. Some embodiments include a linear actuator combined with an appropriate coupling mechanism to the wearer's ankle or foot, which allows the user to bend their knee or go up on their tip-toes while also allowing the exoskeleton to stay in the same location on the ground.

Some embodiments include an exoskeleton having a harness located at a region (e.g., top, upper region) of the exoskeleton corresponding to a wearer's waist region. During use, the harness can be coupled (e.g., fastened, connected) to the wearer's waist, to a load carried on the wearer's back, or to an upper body exoskeleton that can assist the wearer in lifting a load with their hands. A top region of an exoskeleton in some embodiments can correspond to a wearer's waist region and it can include joints between a harness located at the top region and a linear actuator in both the sagittal plane and frontal plane. These joints can be unpowered in some cases, allowing the wearer to move as they wish without hinderance from the exoskeleton. In other embodiments, an exoskeleton can include an actuator in the sagittal plane that can assist the wearer's hip during the swing phase. Some embodiments include an exoskeleton having a joint along the length of a linear actuator that allows rotation along the axis of the leg. This will allow the hip to engage in internal and external rotation, and it will allow the foot to engage in medial and lateral rotation. The joint permitting rotation along the axis of the leg in such embodiments can be located near the wearer's waist or near their foot. At the user's foot, the exoskeleton in these embodiments can be constrained to move in the fore-aft direction and side-side direction with the wearer's foot (e.g., to allow a certain amount of play or tolerance) while also allowing the user's ankle to move in three degrees of freedom.

One possibility is to connect an exoskeleton linear actuator to a wearer's shank (e.g., lower leg between the knee and the ankle). In this case, the exoskeleton can protrude away from a user's body to allow the ankle a full range of motion. As an alternative solution for attaching an exoskeleton to a wearer's shank, some embodiments herein include an exoskeleton having components that are constrained to move with a wearer's foot at a height around the wearer's ankle or below while allowing the foot to move in three degrees of freedom.

The exoskeletons of embodiments herein that extend past the foot to the ground are very beneficial for at least two possible applications in addition to supporting walking or load carriage, including: assisting the wearer to jump; and providing a safe landing if the wearer is falling towards the ground rapidly, for example, when landing with a parachute. In both of these applications, the exoskeletons of the embodiments provide force on the ground over a longer distance of the wearer's center of mass travel as compared to only providing force when the wearer's foot contacts the ground. This is beneficial because it allows for a greater total impulse or for smaller peak forces on the wearer. For jumping, for example, some exoskeleton embodiments can extend between approximately 10 to 50 centimeters (cm) below a user's foot, continuing to push on the ground even after the user has lifted off the ground entirely. The same thing applies for a user landing on the ground after a jump with some exoskeleton embodiments, for instance, landing on the ground after a jump off of a vertically high location or landing with a parachute after a jump out of an aircraft. In each of these cases, the exoskeleton embodiments can contact the ground approximately 10-50 cm or more before a wearer's foot or shoe contacts the ground. By contacting the ground before a wearer's foot or shoe contacts the ground, these exoskeletons extend the distance over which the wearer can decelerate, which in turn reduces the peak forces on the body.

Various exoskeleton embodiments include a linear actuator with a large travel distance to achieve such initial ground contact, although it could also be accomplished with a four-bar linkage in one embodiment or with a single joint located near the wearer's knee in another embodiment. However, in the case of a single joint or four-bar linkage, the exoskeleton may protrude forward or backward from the wearer a large amount. Additionally, the exoskeleton may not extend straight below the wearer's foot in some cases, since the lower end of the exoskeleton can be angled (e.g., if a knee joint is in front of the wearer, the exoskeleton may extend toward the wearer's heel).

With respect to an actuator located between a user's waist region and the ground, a linear extensional actuator may be used in some embodiments as it vastly superior to a hinged design with a single “knee” joint. This is because if a hinged actuator is sized so that its end can touch the ground when the user is standing on their tiptoes, then when they return to a flat-footed position the “knee” can protrude a large distance in front of their body. Also, if the exoskeleton “foot” of such an exoskeleton is attached to a lower link of the exoskeleton below the “knee,” when the “knee” protrudes forward from a user's body it can cause the exoskeleton “foot” to rotate forward substantially, contacting the ground in a location that does not match the user's foot. Allowing the hinged actuator to extend even further below the user's foot (e.g., for jumping or landing applications) makes this problem even worse.

Also, to maximally benefit a biological gait of a user, the embodiments can allow for the force from the ground to originate on the average from a position near the center of the user's foot and can further provide forces to a position near the user's waist or torso near the center of the user's body in the fore-aft direction. At the foot, having the force originate from a point near the heel may cause the net force vector to be forward with respect to the center of mass. For example, at 0% in a user's gait cycle, when the user's heel contacts the ground, a line of action from roughly the body's center of mass near the waist to the heel may be approximately vertical. At 30% in the gait cycle (e.g., close to the midpoint of the time when the user's right leg is on the ground), the net force vector may now be forward. At 60% in the gait cycle (e.g., just before the foot lifts off the ground), the force vector may point substantially forward, greater than the rearward angle at 0% in the gait cycle. Thus, there may be a net forward force on the body, which would have to be resisted by muscles in the user's opposite leg. Some embodiments provide a solution to this in the form of an exoskeleton that can compensate for (e.g., offset) such net forward force on the body by weakening (e.g., dampening or reducing) the force during different parts of the gait cycle.

Similarly, having the force from the ground originate near the front of the wearer's foot may result in a net backwards force on the user's body, which will require muscular force to overcome. Some embodiments provide a solution to this in the form of an exoskeleton that can allow for the force from the ground to originate near the center of a user's foot to provide a symmetric force on the user's body, maximally aiding locomotion.

Additionally, having the force near the center of the user's foot minimizes the extra travel distance that the linear actuator must extend below the bottom of the user's foot. For example, if the actuator is positioned near the heel of the user's foot, then it must extend a long distance below the user's foot at close to 60% in the gait cycle, because the heel is high above the ground at this point. If it is positioned near the toe of the user's foot, then it must extend a long distance below the user's foot just after heel strike at 0% in the gait cycle, since the toe is high above the ground at this point. Some embodiments provide a solution to this in the form of an exoskeleton that can allow for the force from the ground to originate near the center of the user's foot to minimize the extra travel distance a linear actuator of the exoskeleton extends below the bottom of the user's foot during a jumping or landing application, for instance.

The exoskeleton embodiments described herein are lower cost and simpler compared to existing exoskeletons such as, for instance, existing lower body exoskeletons. One application of the embodiments can be to provide mobility assistance to mobility impaired individuals. Additionally, the embodiments could be useful for military applications such as load carriage over long distances and reducing leg injuries for paratroopers, for instance. Some embodiments (e.g., in combination with an upper body exoskeleton) can allow a wearer to lift and carry loads of more than 100 pounds. For instance, some embodiments can be used in conjunction with arm modules to allow a wearer to lift and carry loads of more than 100 pounds but for a tenth of the price compared to existing exoskeletons.

For applications such as assisting unloaded or loaded walking, the exoskeleton embodiments described herein can offset a user's body weight and can create forces that make locomotion easier. For instance, traditional lower body exoskeletons have individual motors at the hip, knee, and ankle, which requires a significant amount of mass for the motors and links between them, and also makes control of the exoskeleton complex. Instead of using individual joints and actuators, various exoskeleton embodiments herein include a single prismatic actuator that creates a force between the ground and a user's center of mass. In conjunction with different component configurations for coupling a lower end of an actuator to a user's foot, the embodiments allow natural walking while supporting relatively high loads. The embodiments can be used in a multitude of applications, for instance, to augment unloaded walking or to assist individuals in carrying heavy loads on their backs, among others.

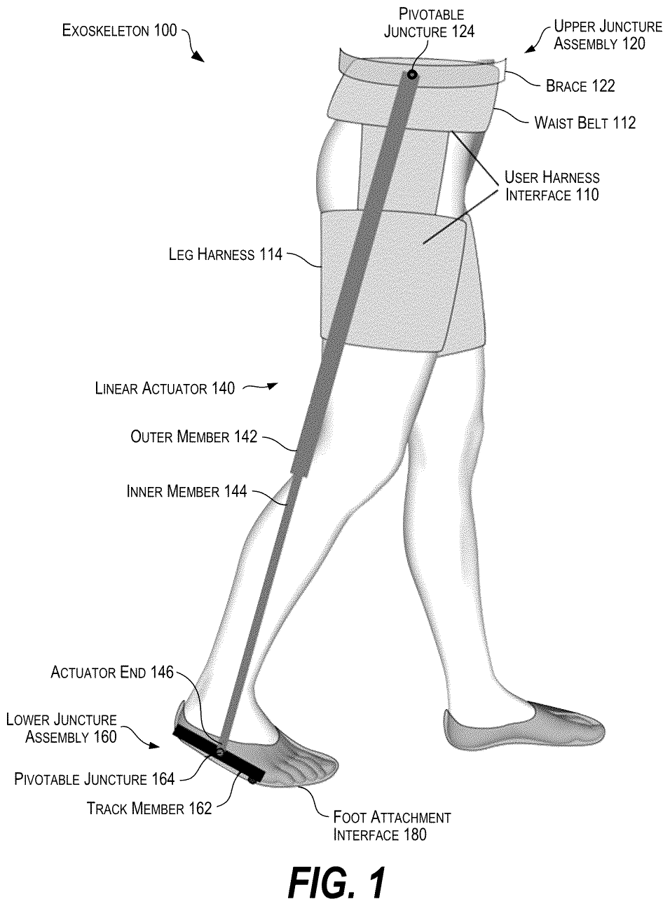

For context, FIG. 1 illustrates a side view of an example exoskeleton 100 according to various aspects and embodiments of the present disclosure. The exoskeleton 100 can be designed, embodied, and implemented as a lower body exoskeleton according to different examples described herein. The exoskeleton 100 depicted in FIG. 1 is one illustrative example of an exoskeleton of the present disclosure. In other examples, the exoskeleton 100 can include one or more different or additional components compared to those shown in FIG. 1. In some examples, one or more components illustrated in FIG. 1 may be omitted from the exoskeleton 100. In some cases, one or more components of another exoskeleton embodiment described herein or illustrated in the figures may be included in the exoskeleton 100 in place of or in addition to one or more components shown in FIG. 1 to form a different embodiment of the exoskeleton 100. All such exoskeleton embodiment variations are envisioned and included within the scope of the present disclosure.

The exoskeleton 100 includes a user harness interface 110, an upper juncture assembly 120, at least one linear actuator 140, at least one lower juncture assembly 160, and at least one foot attachment interface 180, among other components. Only a single linear actuator 140, a single lower juncture assembly 160, a single foot attachment interface 180, and respective components thereof are illustrated and/or denoted in FIG. 1 for clarity. In some embodiments, the exoskeleton 100 may include at least one of a different user harness interface, a different upper juncture assembly, a different and/or additional linear actuator, a different and/or additional lower juncture assembly, or a different and/or additional foot attachment interface compared to what is illustrated in FIG. 1.

The user harness interface 110 includes a waist belt 112 and at least one leg harness 114 coupled to the waist belt 112. Only a single leg harness 114 is denoted in FIG. 1 for clarity. The user harness interface 110 is configured for wearing by a user (e.g., an individual) during implementation of the exoskeleton 100. For instance, the waist belt 112 is configured to be positioned at or approximately at and around a user's waist during implementation of the exoskeleton 100. The waist belt 112 can be at least one of a flexible or an adjustable waist belt in some examples to allow a user to adjust tension in the waist belt 112 around the user's waist.

The upper juncture assembly 120 includes a brace 122 and at least one pivotable juncture 124 coupled to the brace 122 and the waist belt 112 of the user harness interface 110. Only a single pivotable juncture 124 is illustrated and denoted in FIG. 1 for clarity. The brace 122 can be embodied as a rigid or a flexible material such as a metal band, for instance, although another material may be used. In some examples, the brace 122 can be integrated in the waist belt 112, for instance, included in an inner lining of or otherwise positioned within the waist belt 112. In another example, the brace 122 can be positioned on an outer surface of the waist belt 112. In the example shown, the brace 122 is coupled to the waist belt 112 by way of one or more pivotable junctures 124 or another pivotable juncture. The brace 122 can be embodied such that it extends at least partly around a user's waist to transmit various forces directly to a user's center of body (e.g., center of mass) during implementation of the exoskeleton 100. For instance, the brace 122 can extend at least from a front region of a user's waist to a back region of the user's waist. In this example, the brace 122 can be coupled by way of a first pivotable juncture to a first location on the waist belt 112 that is proximate the front region of the user's waist and can be further coupled by way of a second pivotable juncture to a second location on the waist belt 112 that is proximate the back region of the user's waist. It is also possible for the brace 122 to extend only to either the front or back of the wearer but not the other.

The linear actuator 140 includes an outer member 142 and an inner member 144.

In the example shown the inner member 144 is embodied as a cylinder or tube having a circular or annular-shaped cross-section and the outer member 142 is embodied and configured to receive such a cylinder or tube. In other examples, the inner member 144 can be embodied to have another geometry or cross-sectional shape such as, for instance, a triangular-shaped cross section, a square-shaped cross-section, a rectangular-shaped cross-section, or another cross-sectional shape. In these examples, the outer member 142 can be embodied and configured to receive such an inner member 144 having any of such cross-sectional shapes. In one example, the outer member 142 can include an aluminum or aluminum alloy material, although another material may be used in some cases. In another example, the inner member 144 can include a carbon fiber material or aluminum material, although other materials may be used in some cases. One end of the outer member 142 is coupled to the brace 122 by way of the pivotable juncture 124, and an opposite end of the outer member 142 is configured to receive the inner member 144. In another embodiment, one end of the outer member 142 may be coupled to the brace 122 by way of the pivotable juncture 124, and another location on the outer member 142 such as along an external side of the outer member 142 may be configured to receive or otherwise guide the inner member 144 in a linear manner. The outer member 142 and the inner member 144 are configured such that the inner member 144 slides in (e.g., contraction) and out (e.g., extension) of the outer member 142 when one or more linear forces are applied to at least one of the outer member 142 or the inner member 144 by the linear actuator 140. In some examples, the linear actuator 140 can include a drive system (e.g., a motor, belt or chain, and pulley or sprocket; or a pneumatic or hydraulic system) that can generate and apply such linear force or forces to at least one of the outer member 142 or the inner member 144. The inner member 144 of the linear actuator 140 includes an actuator end 146 located at or approximately at an end (e.g., bottom, distal, lower end) of the inner member 144. The actuator end 146 is embodied and configured such that it can be positioned proximate or adjacent to a user's foot.

In some embodiments, the linear actuator 140 can include a clutch in place of or in addition to a drive system. For instance, the linear actuator 140 can include a clutch between the outer member 142 and the inner member 144 in place of or in addition to a drive system. Such a clutch can prevent the outer member 142 from moving relative to the inner member 144. When active, this clutch can allow a motor coupled to the linear actuator 140 of such an exoskeleton embodiment to not be active, thereby saving power. The clutch can also be used when a person is standing still, to hold the linear actuator 140 of such an embodiment at a fixed length and support the person's body weight. The clutch can be manually controlled (e.g., with a lever or knob), electronically controlled, or controlled using another method or mechanism (e.g., pneumatically).

The lower juncture assembly 160 includes a track member 162 coupled to the actuator end 146 and the foot attachment interface 180. The track member 162 can be coupled to a side of the foot attachment interface 180. In the example shown, the track member 162 is coupled to an outer side of the foot attachment interface 180 that corresponds to an outer side of a foot of a user wearing the exoskeleton 100. The track member 162 is coupled to such an outer side of the foot attachment interface 180 in a fore-aft direction relative to at least one of the foot attachment interface 180 or a foot of a user wearing the exoskeleton 100.

The lower juncture assembly 160 also includes a pivotable juncture 164 that couples the track member 162 to the actuator end 146. For instance, the pivotable juncture 164 can be embodied as a ball joint that is coupled to the actuator end 146 and is positioned in the track member 162. The ball joint can be positioned within a slot or channel of the track member 162 such that the ball joint can slide back and forth along the slot in a fore-aft direction relative to at least one of the foot attachment interface 180 or a foot of a user wearing the exoskeleton 100. For example, as the linear actuator 140 generates and applies linear forces to cause the inner member 144 to slide in (e.g., contraction) and out (e.g., extension) of the outer member 142, the ball joint can slide along the track member 162 in such a fore-aft direction while simultaneously transmitting the linear forces to different portions of the track member 162 and the foot attachment interface 180. For instance, the ball joint can slide along the track member 162 to apply the linear forces at certain portions along the track member 162 at certain stages during a user's gait to cause the foot attachment interface 180 to move in a manner that more closely mimics a user's biological gait compared to existing exoskeletons.

The foot attachment interface 180 can be embodied as a rigid or flexible material. In the example shown, the foot attachment interface 180 is embodied as a foot cover. In other examples, the foot attachment interface 180 can be embodied as a shoe or other type of foot cover having components that allow for coupling to at least one of the lower juncture assembly 160 or the linear actuator 140.

The linear actuator 140 in the example shown is coupled by way of the pivotable juncture 164 to the track member 162, which runs fore-aft along the foot attachment interface 180 and a user's foot (e.g., along a path between a user's toes and heel). The track member 162 in this example allows the actuator end 146 of the linear actuator 140 to move forward or backward along the track member 162, the foot attachment interface 180, and a user's foot depending on where the force should be applied. During heel strike of a gait cycle in one example, the actuator end 146 can be located at a position along the track member 162 that is proximate or adjacent to a user's heel. After approximately 30% completion of the gait cycle in this example, the actuator end 146 can be located at a position along the track member 162 that is proximate or adjacent to a user's forefoot.

In some embodiments, the actuator end 146 can move back and forth along the track member 162 by itself as the angle of the linear actuator 140 changes during the gait cycle (e.g., due to an upper end of the linear actuator 140 being coupled to the upper juncture assembly 120 at a user's waist region, which moves forward relative to the user's foot while the foot is on the ground). In other embodiments, the motion of the actuator end 146 can be modulated by springs or dampers that can be included in the track member 162 to allow the actuator end 146 to move at a controllable velocity as a gait cycle progresses. In some embodiments, an additional and smaller actuator can be mounted next to the track member 162 and can push the actuator end 146 back and forth along the track member 162 depending on where a user's body is in a gait cycle. In some embodiments, the track member 162 may be embodied such that it curves upward (e.g., with the lowest point near a center or ball of a user's foot) to help the actuator end 146 move to appropriate locations along the foot attachment interface 180 and a user's foot as a function of the gait cycle. In one embodiment, the pivotable juncture 164 can be embodied as and include a ball joint that couples the actuator end 146 to a sliding carriage on the track member 162. The ball joint allows the foot attachment interface 180 and a user's foot to rotate relative to the linear actuator 140 (e.g., relative to at least one of the outer member 142 or the inner member 144).

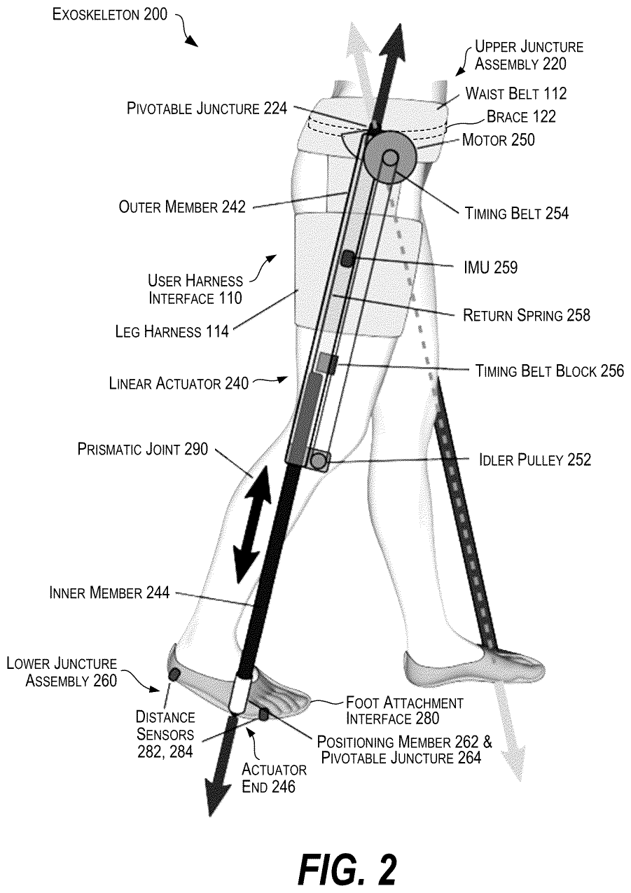

FIG. 2 illustrates a side view of another example exoskeleton 200 according to various aspects and embodiments of the present disclosure. The exoskeleton 200 can be designed, embodied, and implemented as a lower body exoskeleton according to different examples described herein. The exoskeleton 200 depicted in FIG. 2 is one illustrative example of an exoskeleton of the present disclosure. In other examples, the exoskeleton 200 can include one or more different or additional components compared to those shown in FIG. 2. In some examples, one or more components illustrated in FIG. 2 may be omitted from the exoskeleton 200. In some cases, one or more components of another exoskeleton embodiment described herein or illustrated in the figures may be included in the exoskeleton 200 in place of or in addition to one or more components shown in FIG. 2 to form a different embodiment of the exoskeleton 200. All such exoskeleton embodiment variations are envisioned and included within the scope of the present disclosure.

The exoskeleton 200 is an example alternative embodiment of the exoskeleton 100 described herein and illustrated in FIG. 1. For instance, the exoskeleton 200 can include the same or similar components, structure, materials, attributes, and functions as that of the exoskeleton 100. A difference between the exoskeleton 200 and the exoskeleton 100 is that the exoskeleton 200 includes a different upper juncture assembly, a different linear actuator, a different lower juncture assembly, and a different foot attachment interface compared to that of the exoskeleton 100.

The exoskeleton 200 includes the user harness interface 110, an upper juncture assembly 220, at least one linear actuator 240, at least one lower juncture assembly 260, and at least one foot attachment interface 280, among other components. Only a single linear actuator 240, a single lower juncture assembly 260, a single foot attachment interface 280, and respective components thereof are illustrated and/or denoted in FIG. 2 for clarity. In some embodiments, the exoskeleton 200 may include at least one of a different user harness interface, a different upper juncture assembly, a different and/or additional linear actuator, a different and/or additional lower juncture assembly, or a different and/or additional foot attachment interface compared to what is illustrated in FIG. 2.

The upper juncture assembly 220 includes the brace 122 and at least one pivotable juncture 224 coupled to the brace 122 and the waist belt 112 of the user harness interface 110. Only a single pivotable juncture 224 is illustrated and denoted in FIG. 2 for clarity. In the example shown, the brace 122 is embodied as a rigid insert integrated in the waist belt 112, for instance, included in an inner lining of or otherwise positioned within the waist belt 112. In one example, the pivotable juncture 224 can be embodied as a universal joint. In another example, the pivotable juncture 224 can include a spring.

The linear actuator 240 includes an outer member 242 and an inner member 244.

The outer member 242 is depicted as partially transparent in FIG. 2 to reveal additional components of the linear actuator 240 described herein. In the example shown the inner member 244 is embodied as a cylinder or tube having a circular or annular-shaped cross-section and the outer member 242 is embodied and configured to receive such a cylinder or tube. In other examples, the inner member 244 can be embodied to have another geometry or cross-sectional shape such as, for instance, a triangular-shaped cross section, a square-shaped cross-section, a rectangular-shaped cross-section, or another cross-sectional shape. In these examples, the outer member 242 can be embodied and configured to receive such an inner member 244 having any of such cross-sectional shapes. In one example, the outer member 242 can include an aluminum or aluminum alloy material, although another material may be used in some cases. In another example, the inner member 244 can include a carbon fiber material, although another material such as aluminum or an aluminum alloy may be used in some cases. A first end (e.g., top, distal, upper end) of the outer member 242 is coupled to the brace 122 by way of the pivotable juncture 224, and a second end (e.g., bottom, distal, lower end) of the outer member 242 opposite the first end is configured to receive the inner member 244. The inner member 244 includes a first end (e.g., top, distal, upper end) that is configured to slide in and out of the outer member 242. The inner member 244 further includes a second end (e.g., bottom, distal, lower end) referred to herein as actuator end 246 that is opposite the first end of the inner member 244. The actuator end 246 is embodied and configured such that it can be positioned proximate or adjacent to a user's foot.

The outer member 242 and the inner member 244 are configured such that the inner member 244 slides in (e.g., contraction) and out (e.g., extension) of the outer member 242 when one or more linear forces are applied to at least one of the outer member 242 or the inner member 244 by the linear actuator 240. In the example shown, the linear actuator 240 further includes a drive system that can generate and apply such linear force or forces to at least one of the outer member 242 or the inner member 244, thereby creating a prismatic joint 290. The drive system of the linear actuator 240 includes a motor 250, an idler pulley 252, a timing belt 254, a timing belt block 256, a return spring 258, and an inertial measurement unit (IMU) 259 (or “IMU 259”), among other components.

The motor 250 is coupled to the first end (e.g., top, distal, upper end) of the outer member 242 and the idler pulley 252 is coupled to the second end (e.g., bottom, distal, lower end) of the outer member 242. In other examples, the motor 250 may be coupled to the second end of the outer member 242 and the idler pulley 252 may be coupled to the first end of the outer member 242. The motor 250 is coupled to the idler pulley 252 by way of the timing belt 254 in the example shown. In other examples, the drive system of the linear actuator 240 may include a drive sprocket and chain system instead of the idler pulley 252 and the timing belt 254. For instance, the motor 250 may include a first drive sprocket and a second drive sprocket may be coupled to the second end (e.g., bottom, distal, lower end) of the outer member 242 in place of the idler pulley 252 in some cases. In these examples, the first drive sprocket of the motor 250 may be coupled to the second drive sprocket instead of the idler pulley 252 by way of a chain instead of the timing belt 254. Any or all of the timing belt block 256, the return spring 258, or the IMU 259 can be integrated into or otherwise coupled to the outer member 242. In the example shown, at least one of the timing belt block 256 or the IMU 259 can be integrated into the outer member 242 (e.g., as a continuous or contiguous component of the outer member 242) or coupled to one or more internal or external surfaces of the outer member 242. In this example, the return spring 258 is positioned inside the outer member 242 between the first end (e.g., top, distal, upper end) of the inner member 244 and an internal surface of the outer member 242.

In some embodiments, the linear actuator 240 can include a clutch such as a rotational clutch in place of or in addition to the motor 250. For instance, the linear actuator 240 can include a rotational clutch at the location of the motor 250, for example, integrated into the motor 250 in order to hold its position with low power. In another embodiment, the linear actuator 240 can include a clutch instead of the motor 250. The clutch can allow the linear actuator 240 to not compress, supporting a wearer's body weight. The clutch can be manually controlled (e.g., with a lever or knob), electronically controlled, or controlled using another method or mechanism (e.g., pneumatically). For example, the clutch can be a spring-wrap clutch that grips a shaft supporting an upper sprocket coupled to the idler pulley 252 by way of a chain or belt. The clutch could also grip a shaft when a lever is actuated by clamping onto the shaft in some cases. In one embodiment, the linear actuator 240 can include a linear clutch directly coupling the outer member 242 and the inner member 244.

The lower juncture assembly 260 includes a positioning member 262 and a pivotable juncture 264 coupled to the foot attachment interface 280. In the example shown the positioning member 262 is embodied as a tube having an annular-shaped cross-section and is configured to receive and guide the inner member 244. In other examples, the positioning member 262 can be embodied as a tube having another geometry or cross-sectional shape such as, for instance, a triangular-shaped cross section, a square-shaped cross-section, a rectangular-shaped cross-section, or another cross-sectional shape. In these examples, the positioning member 262 can be embodied and configured to receive an inner member 244 also having any of such cross-sectional shapes.

The positioning member 262 and the pivotable juncture 264 can be coupled to a side of the foot attachment interface 280. In the example shown, the positioning member 262 and the pivotable juncture 264 are coupled to an outer side of the foot attachment interface 280 that corresponds to an outer side of a foot of a user wearing the exoskeleton 200. The positioning member 262 is embodied and configured to receive and guide the actuator end 246 of the linear actuator 240 through at least a portion of the positioning member 262. In the example shown, the positioning member 262 is embodied and configured to allow the actuator end 246 to extend through an entire length of the positioning member 262 and beyond an end of the positioning member 262. For instance, the positioning member 262 is embodied and configured to allow the actuator end 246 to extend through the positioning member 262 and further to the ground. The positioning member 262 and the pivotable juncture 264 can be collectively configured to allow for rotation of at least one of a user's foot, ankle, or hip (e.g., to adjust the pitch, yaw, or roll of the user's foot).

In one example, the pivotable juncture 264 can be embodied as a ball joint that is coupled to the positioning member 262 and the foot attachment interface 280. The ball joint can be coupled to the positioning member 262 and the foot attachment interface 280 in a manner that allows the foot attachment interface 280 to have at least one degree of freedom (e.g., at least one rotational degree of freedom) relative to at least one of the positioning member 262 or the inner member 244. In one example, a portion of the ball joint can be integrated into or coupled to an external surface of the positioning member 262 and another portion of the ball joint can be positioned within a slot or channel of the foot attachment interface 280 such that the foot attachment interface 280 can rotate about the ball joint relative to at least one of the positioning member 262 or the inner member 244. For example, as the linear actuator 240 generates and applies linear forces using the motor 250, the idler pulley 252, and the timing belt 254 to cause the inner member 244 to slide in (e.g., contraction) and out (e.g., extension) of the outer member 242, the foot attachment interface 280 can rotate about the ball joint in at least one degree of freedom relative to at least one of the positioning member 262 or the inner member 244.

The foot attachment interface 280 can be embodied as a rigid or flexible material. In the example shown, the foot attachment interface 280 includes two distance sensors 282, 284 respectively positioned at a heel region and a forefoot region (e.g., toe region) of the foot attachment interface 280. A different quantity of distance sensors or a different sensor location may be used in some cases. The distance sensors 282, 284 can be integrated into, embedded in, or otherwise coupled to a surface of the foot attachment interface 280. In the example shown, the foot attachment interface 280 is embodied as a foot cover. In other examples, the foot attachment interface 280 can be embodied as a shoe or other type of foot cover having components that allow for coupling to at least one of the lower juncture assembly 260 or the linear actuator 240. In some embodiments, one or more IMUs may be integrated into, embedded in, or otherwise coupled to a surface of the foot attachment interface 280 in place of or in addition to the distance sensors 282, 284.

In the example shown, the linear actuator 240 can be powered in the extensional direction by the motor 250 (e.g., via the timing belt 254 or another flat belt that is connected to a carriage on the linear actuator 240 and pulls downward; the belt can wrap around the idler pulley 252 at the midpoint of the linear actuator 240 and extend upward to the motor 250 where it can wrap around a spool coupled to the motor 250). In this example, the return spring 258 can be embodied as a natural gum rubber or a metal extension spring that can be used to pull the lower half of the linear actuator 240 upward (e.g., to pull the inner member 244, the lower juncture assembly 260, and the foot attachment interface 280 upward). Using such a spring return is possible because the linear actuator 240 can push with a variable force downward; using a belt that only pulls downward in some embodiments may result in a smaller form factor than a closed-loop belt. However, it is likely that a closed-loop belt of some embodiments can be simpler to control. In the upward direction, the linear actuator 240 can provide a force that offsets the weight of a user's foot and that of the lower half of the linear actuator 240 during the swing phase of walking. Thus, the user may not need to lift their own foot using their muscles, because an upward force on their foot can be created with the linear actuator. For instance, the linear actuator 240 can provide a force that offsets the weight of a user's foot and that of the inner member 244, the lower juncture assembly 260, and the foot attachment interface 280 during the swing phase of walking.

In some embodiments, the exoskeleton 200 can include an extension spring that moves in a direction that is parallel with the linear actuator 240 to extend the actuator. For instance, one end of such an extension spring can be coupled to the first end of the outer member 242 near the wearer's hip and another end of the extension spring can be coupled to the second end of the outer member 242 near the idler pulley 252. In other embodiments, the exoskeleton 200 can include an extension spring around its own idler pulley with a lower end of the extension spring being connected directly to the top of the lower half of the linear actuator 240. In any of such cases, these arrangements can pull the lower half (e.g., the inner member 244) of the linear actuator 240 down with respect to the upper half (e.g., the outer member 242), thereby extending the linear actuator 240. Another embodiment of the exoskeleton 200 can include a compression spring (e.g. a fiberglass or carbon fiber leaf spring) that couples between the top of the linear actuator 240 (e.g., to the first end of the outer member 242 near the hip) and the bottom of the linear actuator 240 (e.g., to at least one of the actuator end 246, the lower juncture assembly 260, or the foot attachment interface 280 near the foot). This embodiment can provide an extension force when the linear actuator 240 shortens, due to the compression spring shortening.

Regardless of the architecture, since forces the linear actuator 240 can provide in extension (e.g., to support a portion of a user's bodyweight or a carried load) can be much larger than forces the linear actuator 240 can provide in retraction (e.g., to support the lower part of the linear actuator 240 and a user's foot), embodiments that include one of the aforementioned extension springs that causes the actuator to extend can enhance the force from the motor 250 in the extension direction. In these embodiments, the motor 250 can resist the spring force in order to lift at least one of the actuator end 246 or the foot attachment interface 280 off the ground, which occurs during a swing phase.

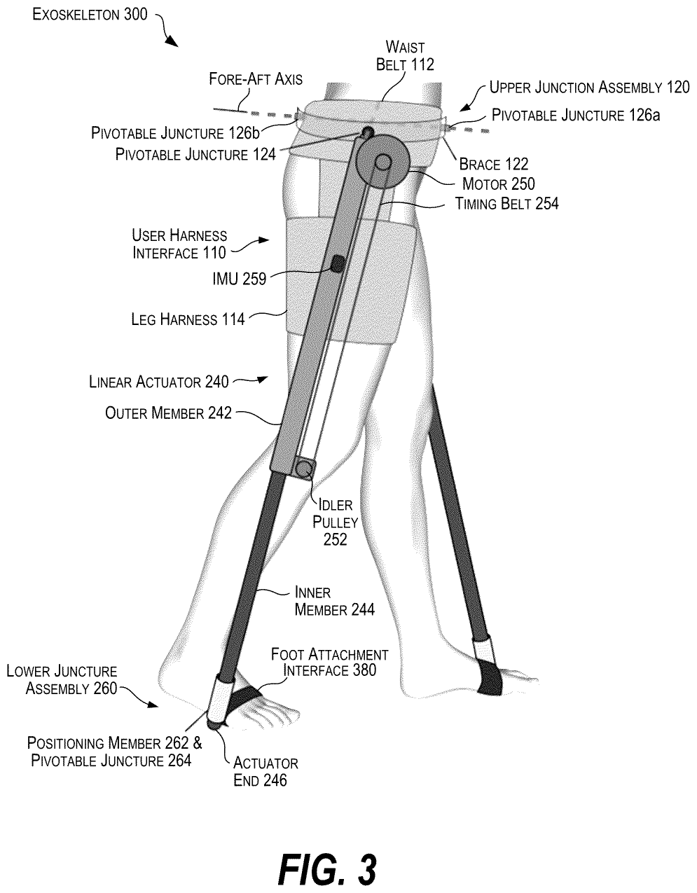

FIG. 3 illustrates a side view of another example exoskeleton 300 according to various aspects and embodiments of the present disclosure. The exoskeleton 300 can be designed, embodied, and implemented as a lower body exoskeleton according to different examples described herein. The exoskeleton 300 depicted in FIG. 3 is one illustrative example of an exoskeleton of the present disclosure. In other examples, the exoskeleton 300 can include one or more different or additional components compared to those shown in FIG. 3. In some examples, one or more components illustrated in FIG. 3 may be omitted from the exoskeleton 300. In some cases, one or more components of another exoskeleton embodiment described herein or illustrated in the figures may be included in the exoskeleton 300 in place of or in addition to one or more components shown in FIG. 3 to form a different embodiment of the exoskeleton 300. All such exoskeleton embodiment variations are envisioned and included within the scope of the present disclosure.

The exoskeleton 300 is an example alternative embodiment of the exoskeletons 100, 200 described herein and illustrated in FIGS. 1 and 2, respectively. For instance, the exoskeleton 300 can include the same or similar components, structure, materials, attributes, and functions as that of at least one of the exoskeletons 100, 200. A difference between the exoskeleton 300 and the exoskeleton 100 is that the exoskeleton 300 includes a different linear actuator, a different lower juncture assembly, and a different foot attachment interface compared to that of the exoskeleton 100. A difference between the exoskeleton 300 and the exoskeleton 200 is that the exoskeleton 300 includes a different upper juncture assembly and a different foot attachment interface compared to that of the exoskeleton 200.

The exoskeleton 300 includes the user harness interface 110, the upper juncture assembly 120, at least one linear actuator 240, a least one lower juncture assembly 260, and at least one foot attachment interface 380, among other components. Only a single linear actuator 240, a single lower juncture assembly 260, a single foot attachment interface 380, and respective components thereof are illustrated and/or denoted in FIG. 3 for clarity. In some embodiments, the exoskeleton 300 may include at least one of a different user harness interface, a different upper juncture assembly, a different and/or additional linear actuator, a different and/or additional lower juncture assembly, or a different and/or additional foot attachment interface compared to what is illustrated in FIG. 3.

The upper juncture assembly 120 of the exoskeleton 300 includes pivotable junctures 126a, 126b coupled to the brace 122 and the waist belt 112 of the user harness interface 110. For instance, the pivotable juncture 126a is coupled to the brace 122 and the waist belt 112 at a location proximate or adjacent to a front region of a user's waist and the pivotable juncture 126b is coupled to the brace 122 and the waist belt 112 at a location proximate or adjacent to a back region of the user's waist.

The lower juncture assembly 260 includes the positioning member 262 and the pivotable juncture 264 coupled to the foot attachment interface 380. The positioning member 262 and the pivotable juncture 264 can be coupled to a side of the foot attachment interface 380. In the example shown, the positioning member 262 and the pivotable juncture 264 are coupled to an outer side of the foot attachment interface 380 that corresponds to an outer side of a foot of a user wearing the exoskeleton 300. The pivotable juncture 264 can be embodied as a ball joint that is coupled to the positioning member 262 and the foot attachment interface 380. The ball joint can be coupled to the positioning member 262 and the foot attachment interface 380 in a manner that allows the foot attachment interface 380 to have at least one degree of freedom (e.g., at least one rotational degree of freedom) relative to at least one of the positioning member 262 or the inner member 244. In one example, a portion of the ball joint can be integrated into or coupled to an external surface of the positioning member 262 and another portion of the balljoint can be positioned within a slot or channel of the foot attachment interface 380 such that the foot attachment interface 380 can rotate about the ball joint relative to at least one of the positioning member 262 or the inner member 244. For example, as the linear actuator 240 generates and applies linear forces using the motor 250, the idler pulley 252, and the timing belt 254 to cause the inner member 244 to slide in (e.g., contraction) and out (e.g., extension) of the outer member 242, the foot attachment interface 380 can rotate about the ball joint in at least one degree of freedom relative to at least one of the positioning member 262 or the inner member 244.

The foot attachment interface 380 can be embodied as a rigid or flexible material. In the example shown, the foot attachment interface 380 is embodied as a foot strap, band, ring, loop, or brace. In other examples, the foot attachment interface 380 can be embodied as a shoe or other type of foot cover having components that allow for coupling to at least one of the lower juncture assembly 260 or the linear actuator 240.

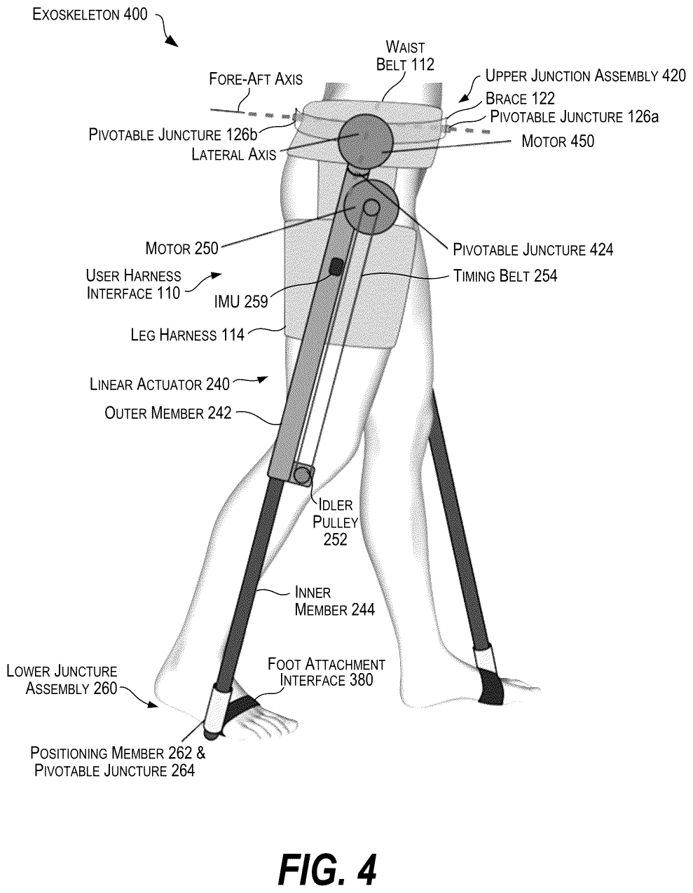

FIG. 4 illustrates a side view of another example exoskeleton 400 according to various aspects and embodiments of the present disclosure. The exoskeleton 400 can be designed, embodied, and implemented as a lower body exoskeleton according to different examples described herein. The exoskeleton 400 depicted in FIG. 4 is one illustrative example of an exoskeleton of the present disclosure. In other examples, the exoskeleton 400 can include one or more different or additional components compared to those shown in FIG. 4. In some examples, one or more components illustrated in FIG. 4 may be omitted from the exoskeleton 400. In some cases, one or more components of another exoskeleton embodiment described herein or illustrated in the figures may be included in the exoskeleton 400 in place of or in addition to one or more components shown in FIG. 4 to form a different embodiment of the exoskeleton 400. All such exoskeleton embodiment variations are envisioned and included within the scope of the present disclosure.

The exoskeleton 400 is an example alternative embodiment of the exoskeleton 300 described herein and illustrated in FIG. 3. For instance, the exoskeleton 400 can include the same or similar components, structure, materials, attributes, and functions as that of the exoskeleton 300. A difference between the exoskeleton 400 and the exoskeleton 300 is that the exoskeleton 400 includes a different upper juncture assembly compared to that of the exoskeleton 300.

The exoskeleton 400 includes the user harness interface 110, an upper juncture assembly 420, at least one linear actuator 240, at least one lower juncture assembly 260, and at least one foot attachment interface 380, among other components. Only a single linear actuator 240, a single lower juncture assembly 260, a single foot attachment interface 380, and respective components thereof are illustrated and/or denoted in FIG. 4 for clarity. In some embodiments, the exoskeleton 400 may include at least one of a different user harness interface, a different upper juncture assembly, a different and/or additional linear actuator, a different and/or additional lower juncture assembly, or a different and/or additional foot attachment interface compared to what is illustrated in FIG. 4.

The upper juncture assembly 420 of the exoskeleton 400 includes a pivotable juncture 426 and a motor 450. The motor 450 is coupled to the brace 122 and to the pivotable juncture 424, and the pivotable juncture 424 is coupled to the first end (e.g., top, distal, upper end) of the outer member 242. In some embodiments, the pivotable juncture 424 may be a component of the linear actuator 240, for instance, it may be integrated into or coupled to an external surface of the outer member 242 at a location that is proximate or adjacent to the first end of the outer member 242. In other embodiments, the pivotable juncture 424 may be a component of the lower juncture assembly 260 or the foot attachment interface 280 such that it is configured to be positioned at a location that is proximate or adjacent to a user's foot. The pivotable juncture 424 can be embodied and configured to provide the exoskeleton 400 with an additional degree of freedom that allows for at least one of internal hip rotation or external hip rotation of a user's hip. The motor 450 can be embodied and configured to provide powered motion in a sagittal plane to assist with at least one of hip flexion or hip extension.

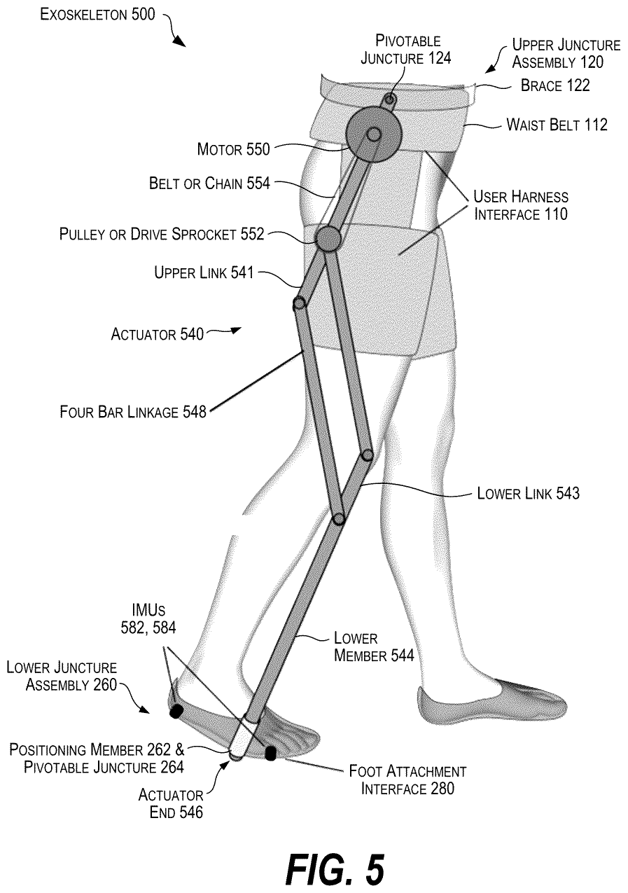

FIG. 5 illustrates a side view of another example exoskeleton 500 according to various aspects and embodiments of the present disclosure. The exoskeleton 500 can be designed, embodied, and implemented as a lower body exoskeleton according to different examples described herein. The exoskeleton 500 depicted in FIG. 5 is one illustrative example of an exoskeleton of the present disclosure. In other examples, the exoskeleton 500 can include one or more different or additional components compared to those shown in FIG. 5. In some examples, one or more components illustrated in FIG. 5 may be omitted from the exoskeleton 500. In some cases, one or more components of another exoskeleton embodiment described herein or illustrated in the figures may be included in the exoskeleton 500 in place of or in addition to one or more components shown in FIG. 5 to form a different embodiment of the exoskeleton 500. All such exoskeleton embodiment variations are envisioned and included within the scope of the present disclosure.

The exoskeleton 500 is an example alternative embodiment of the exoskeletons 100, 200 described herein and illustrated in FIGS. 1 and 2, respectively. For instance, the exoskeleton 500 can include the same or similar components, structure, materials, attributes, and functions as that of at least one of the exoskeletons 100, 200. A difference between the exoskeleton 500 and the exoskeleton 100 is that the exoskeleton 500 includes a different actuator, a different lower juncture assembly, and a different foot attachment interface compared to that of the exoskeleton 100. A difference between the exoskeleton 500 and the exoskeleton 200 is that the exoskeleton 500 includes a different upper juncture assembly, a different actuator, and different foot attachment interface sensors compared to that of the exoskeleton 200.

The exoskeleton 500 includes the user harness interface 110, the upper juncture assembly 120, at least one actuator 540, at least one lower juncture assembly 260, and at least one foot attachment interface 280, among other components. Only a single actuator 540, a single lower juncture assembly 260, a single foot attachment interface 280, and respective components thereof are illustrated and/or denoted in FIG. 5 for clarity. In some embodiments, the exoskeleton 500 may include at least one of a different user harness interface, a different upper juncture assembly, a different and/or additional actuator, a different and/or additional lower juncture assembly, or a different and/or additional foot attachment interface compared to what is illustrated in FIG. 5.

The actuator 540 includes an upper link 541, a lower link 543, a lower member 544, and a four-bar linkage 548. In one example, any or all of the upper link 541, the lower link 543, or the four-bar linkage 548 can include an aluminum or aluminum alloy material, although another material may be used in some cases. In the example shown the lower member 544 is embodied as a cylinder or tube having a circular or annular-shaped cross-section and the positioning member 262 is embodied and configured as a tube that can receive such a cylinder or tube-shaped lower member 544. In other examples, the lower member 544 can be embodied to have another geometry or cross-sectional shape such as, for instance, a triangular-shaped cross section, a square-shaped cross-section, a rectangular-shaped cross-section, or another cross-sectional shape. In these examples, the positioning member 262 can be embodied and configured to receive such a lower member 544 having any of such cross-sectional shapes. In another example, the lower member 544 can include a carbon fiber material or an aluminum alloy, although another material may be used in some cases. A first end (e.g., top, distal, upper end) of the upper link 541 is coupled to the brace 122 by way of the pivotable juncture 124, and a second end (e.g., bottom, distal, lower end) of the upper link 541 partly forms and/or is coupled to the four-bar linkage 548. A first end (e.g., top, distal, upper end) of the four-bar linkage 548 is partly formed by and/or coupled (e.g., pivotably, rotatably) to the second end of the upper link 541, and a second end (e.g., bottom, distal, lower end) of the four-bar linkage 548 opposite the first end is partly formed by and/or coupled to the lower link 543. The lower link 543 partly forms at least one of the four-bar linkage 548 or the lower member 544 and is coupled (e.g., pivotably, rotatably) to both the four-bar linkage 548 and the lower member 544. The lower member 544 includes a first end (e.g., top, distal, upper end) that is partly formed by and/or coupled (e.g., pivotably, rotatably) to the four-bar linkage 548. The lower member 544 further includes a second end (e.g., bottom, distal, lower end) referred to herein as actuator end 546 that is opposite the first end of the lower member 544. The actuator end 546 is embodied and configured such that it can be positioned proximate or adjacent to a user's foot.

The upper link 541, the four-bar linkage 548, the lower link 543, and the lower member 544 are configured such that the lower member 544 slides back (e.g., contraction) and forth (e.g., extension) through the positioning member 262 when one or more linear forces are applied to at least one of the upper link 541, the four-bar linkage 548, the lower link 543, or the lower member 544 by the actuator 540. In the example shown, the actuator 540 further includes a drive system that can generate and apply such linear force or forces to at least one of the upper link 541, the four-bar linkage 548, the lower link 543, or the lower member 544. The drive system of the actuator 540 includes a motor 550, a pulley or drive sprocket 552, and a belt or chain 554, among other components.

The motor 550 is coupled to the first end (e.g., top, distal, upper end) of the upper link 541 and the pulley or drive sprocket 552 is coupled to the first end (e.g., top, distal, upper end) of the four-bar linkage 548. In other examples, the motor 550 may be coupled to at least one of the first end (e.g., top, distal, upper end) of the four-bar linkage 548 or the upper link 541, and the pulley or drive sprocket 552 may be coupled to at least one of the second end (e.g., bottom, distal, lower end) of the four-bar linkage 548 or the lower link 543. The motor 550 is coupled to the pulley or drive sprocket 552 by way of the belt or chain 554 in the example shown. The pulley or drive sprocket 552 can be embodied as either a pulley (e.g., the idler pulley 252) or a drive sprocket. The belt or chain 554 can be embodied as either a belt (e.g., the timing belt 254) or a chain or a cord or rope or piece of webbing.

In some cases, exoskeleton embodiments having the four-bar linkage 548 positioned between a user's hip and foot as illustrated in FIG. 5, for instance, allow for a greater range of motion compared to exoskeleton embodiments having either of the linear actuators 140 or 240. For example, the four-bar linkage 548 can allow for a greater travel distance, while maintaining the orientation of the lower end of the actuator 540. For instance, the four-bar linkage 548 can also allow a user to sit down on a seat fully.

At the foot attachment interface 280, the sensors attached are inertial measurement units (IMUs) 582, 584 (or “IMUs 582, 584”). In the example shown, the foot attachment interface 280 includes two IMUs 582, 584 respectively positioned at a heel region and a forefoot region (e.g., toe region) of the foot attachment interface 280. A different quantity of IMUs or a different sensor location may be used in some cases. The IMUs 582, 584 can be integrated into, embedded in, or otherwise coupled to a surface of the foot attachment interface 280. They can also be used simultaneously with distance sensors also attached to the foot attachment interface 280.

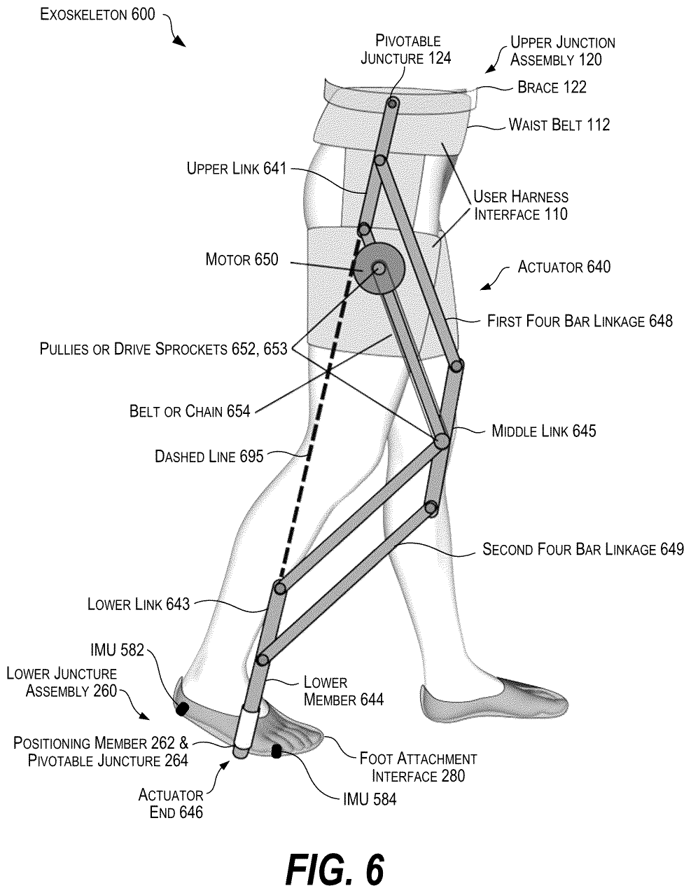

FIG. 6 illustrates a side view of another example exoskeleton 600 according to various aspects and embodiments of the present disclosure. The exoskeleton 600 can be designed, embodied, and implemented as a lower body exoskeleton according to different examples described herein. The exoskeleton 600 depicted in FIG. 6 is one illustrative example of an exoskeleton of the present disclosure. In other examples, the exoskeleton 600 can include one or more different or additional components compared to those shown in FIG. 6. In some examples, one or more components illustrated in FIG. 6 may be omitted from the exoskeleton 600. In some cases, one or more components of another exoskeleton embodiment described herein or illustrated in the figures may be included in the exoskeleton 600 in place of or in addition to one or more components shown in FIG. 6 to form a different embodiment of the exoskeleton 600. All such exoskeleton embodiment variations are envisioned and included within the scope of the present disclosure.

The exoskeleton 600 is an example alternative embodiment of the exoskeleton 500 described herein and illustrated in FIG. 5. For instance, the exoskeleton 600 can include the same or similar components, structure, materials, attributes, and functions as that of the exoskeleton 500. A difference between the exoskeleton 600 and the exoskeleton 500 is that the exoskeleton 600 includes a different actuator compared to that of the exoskeleton 500.

The exoskeleton 600 includes the user harness interface 110, the upper juncture assembly 120, at least one actuator 640, at least one lower juncture assembly 260, and at least one foot attachment interface 280 (e.g., with IMUs 582, 584), among other components. Only a single actuator 640, a single lower juncture assembly 260, a single foot attachment interface 280, and respective components thereof are illustrated and/or denoted in FIG. 6 for clarity. In some embodiments, the exoskeleton 600 may include at least one of a different user harness interface, a different upper juncture assembly, a different and/or additional actuator, a different and/or additional lower juncture assembly, or a different and/or additional foot attachment interface compared to what is illustrated in FIG. 6.

The actuator 640 includes an upper link 641, a lower link 643, a middle link 645, a lower member 644, a first four-bar linkage 648, and a second four-bar linkage 649. In one example, any or all of the upper link 641, the lower link 643, the middle link 645, the first four-bar linkage 648, or the second four-bar linkage 649 can include an aluminum or aluminum alloy material, although another material may be used in some cases. In the example shown the lower member 644 is embodied as a cylinder or tube having a circular or annular-shaped cross-section and the positioning member 262 is embodied and configured as a tube that can receive such a cylinder or tube-shaped lower member 644. In other examples, the lower member 644 can be embodied to have another geometry or cross-sectional shape such as, for instance, a triangular-shaped cross section, a square-shaped cross-section, a rectangular-shaped cross-section, or another cross-sectional shape. In these examples, the positioning member 262 can be embodied and configured to receive such a lower member 644 having any of such cross-sectional shapes. In another example, the lower member 644 can include a carbon fiber material, although another material may be used in some cases. A first end (e.g., top, distal, upper end) of the upper link 641 is coupled to the brace 122 by way of the pivotable juncture 124, and a second end (e.g., bottom, distal, lower end) of the upper link 641 partly forms and/or is coupled to the first four-bar linkage 648. A first end (e.g., top, distal, upper end) of the first four-bar linkage 648 is partly formed by and/or coupled (e.g., pivotably, rotatably) to the second end of the upper link 641, and a second end (e.g., bottom, distal, lower end) of the first four-bar linkage 648 opposite the first end is partly formed by and/or coupled to the middle link 645. The middle link 645 partly forms at least one of the first four-bar linkage 648 or the second four-bar linkage 649 and is coupled (e.g., pivotably, rotatably) to both the first four-bar linkage 648 and the second four-bar linkage 649. The lower link 643 partly forms at least one of the second four-bar linkage 649 or the lower member 644 and is coupled (e.g., pivotably, rotatably) to both the second four-bar linkage 649 and the lower member 644. The lower member 644 includes a first end (e.g., top, distal, upper end) that is partly formed by and/or coupled (e.g., pivotably, rotatably) to the lower link 643. The lower member 644 further includes a second end (e.g., bottom, distal, lower end) referred to herein as actuator end 646 that is opposite the first end of the lower member 644. The actuator end 646 is embodied and configured such that it can be positioned proximate or adjacent to a user's foot.

The upper link 641, the first four-bar linkage 648, the middle link 645, the second four-bar linkage 649, the lower link 643, and the lower member 644 are configured such that the lower member 644 slides back (e.g., contraction) and forth (e.g., extension) through the positioning member 262 when one or more linear forces are applied to at least one of the upper link 641, the first four-bar linkage 648, the middle link 645, the second four-bar linkage 649, the lower link 643, or the lower member 644 by the actuator 640. In the example shown, the actuator 640 further includes a drive system that can generate and apply such linear force or forces to at least one of the upper link 641, the first four-bar linkage 648, the middle link 645, the second four-bar linkage 649, the lower link 643, or the lower member 644. The drive system of the actuator 640 includes a motor 650, pullies or drive sprockets 652, 653, and a belt or chain 654, among other components.

The motor 650 is coupled to the first end (e.g., top, distal, upper end) of the first four-bar linkage 648 and the pulley or drive sprocket 653 is coupled to at least one of the second end (e.g., bottom, distal, lower end) of the first four-bar linkage 648 or the middle link 645. In other examples, the motor 650 may be coupled to at least one of the second end (e.g., bottom, distal, lower end) of the first four-bar linkage 648 or the middle link 645, and the pulley or drive sprocket 653 may be coupled to at least one of the first end (e.g., top, distal, upper end) of the first four-bar linkage 648 or the upper link 641. The motor 650 is coupled to the pulley or drive sprocket 653 by way of the belt or chain 654 in the example shown. Each of the pullies or drive sprockets 652, 653 can be embodied as either a pulley (e.g., the idler pulley 252) or a drive sprocket. The belt or chain 654 can be embodied as either a belt (e.g., the timing belt 254) or a chain.

In the example shown, the motor 650 can drive a lower half of the actuator 640 relative to an upper half of the actuator 640 so that a joint created at a center of the actuator 640 extends or retracts (e.g., changes its angle). The first and second four-bar linkages 648, 649 cause the lower half of the actuator 640 to remain aligned with the upper half of the actuator 640, so that the two ends remain collinear as indicated by a dashed line 695 in FIG. 6. For instance, the actuator 640 allows its upper and lower ends to remain collinear while providing an increased range of motion compared to exoskeletons having a linear actuator.

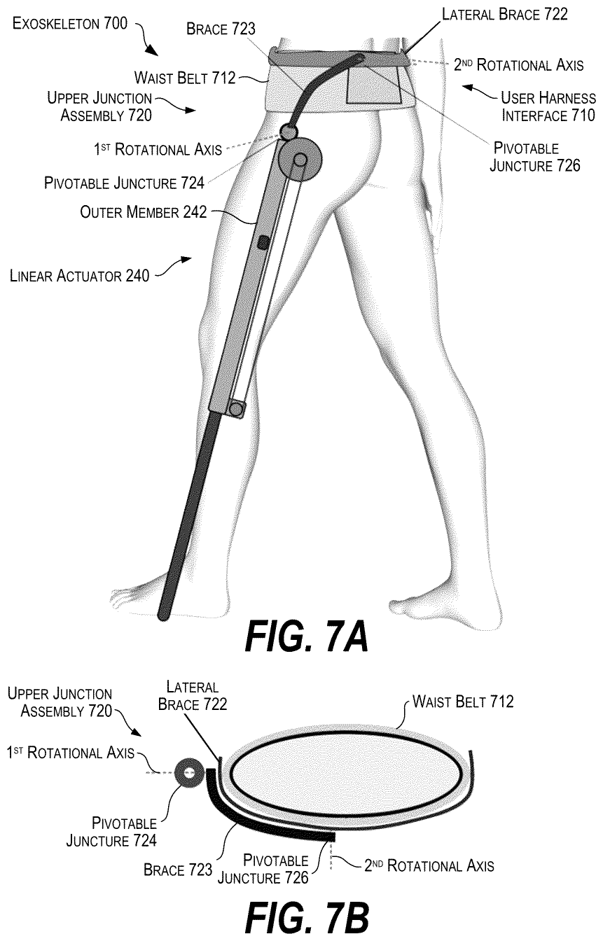

FIG. 7A illustrates a perspective view of another example exoskeleton 700 according to various aspects and embodiments of the present disclosure. FIG. 7B illustrates a top view of the example exoskeleton 700 according to various aspects and embodiments of the present disclosure. The exoskeleton 700 can be designed, embodied, and implemented as a lower body exoskeleton according to different examples described herein. The exoskeleton 700 depicted in FIGS. 7A and 7B is one illustrative example of an exoskeleton of the present disclosure. In other examples, the exoskeleton 700 can include one or more different or additional components compared to those shown in FIGS. 7A and 7B. In some examples, one or more components illustrated in FIG. 7A or 7B may be omitted from the exoskeleton 700. In some cases, one or more components of another exoskeleton embodiment described herein or illustrated in the figures may be included in the exoskeleton 700 in place of or in addition to one or more components shown in FIGS. 7A and 7B to form a different embodiment of the exoskeleton 700. All such exoskeleton embodiment variations are envisioned and included within the scope of the present disclosure.

The exoskeleton 700 is an example alternative embodiment of the exoskeleton 300 described herein and illustrated in FIG. 3. For instance, the exoskeleton 700 can include the same or similar components, structure, materials, attributes, and functions as that of the exoskeleton 300. A difference between the exoskeleton 700 and the exoskeleton 300 is that the exoskeleton 700 includes a different user harness interface and a different upper juncture assembly compared to that of the exoskeleton 300. A lower juncture assembly and foot attachment interface are omitted from the example shown for clarity.

Referring to FIGS. 7A and 7B, the exoskeleton 700 includes a user harness interface 710, an upper juncture assembly 720, and at least one linear actuator 240, among other components. Only a single linear actuator 240 is illustrated and denoted in FIG. 7A for clarity. In some embodiments, the exoskeleton 700 may include at least one of a different user harness interface, a different upper juncture assembly, or a different and/or additional linear actuator compared to what is illustrated in FIGS. 7A and 7B.

The user harness interface 710 includes a waist belt 712 configured for wearing by a user (e.g., an individual) during implementation of the exoskeleton 700. For instance, the waist belt 712 is configured to be positioned at or approximately at and around a user's waist during implementation of the exoskeleton 700. The waist belt 712 can be at least one of a flexible or an adjustable waist belt in some examples to allow a user to adjust tension in the waist belt 712 around the user's waist.

The upper juncture assembly 720 includes a lateral brace 722, at least one brace 723, at least one pivotable juncture 724, and at least one pivotable juncture 726. The lateral brace 722 can be coupled to an outer surface of the waist belt 712 of the user harness interface 710 by way of, for instance, an adhesive, although another fastener may be used in some cases. The lateral brace 722 can be embodied as a rigid or a flexible material such as a metal band, for instance, although another material may be used. In some examples, the lateral brace 722 can be integrated in the waist belt 712, for instance, included in an inner lining of or otherwise positioned within the waist belt 712.

The lateral brace 722 can be embodied such that it extends at least partly or completely around a user's waist to transmit various forces directly to a user's center of body (e.g., center of mass) during implementation of the exoskeleton 700. For instance, the lateral brace 722 can extend at least from a left-side region of a user's waist to a right-side region of the user's waist. In this example, the lateral brace 722 is coupled by way of the pivotable juncture 726 to a first end (e.g., top, distal, upper end) of the brace 723 at a location on the waist belt 712 that is proximate or adjacent to a back region of a user's waist. A second end (e.g., bottom, distal, lower end) of the brace 723 in this example is coupled by way of the pivotable juncture 724 to the first end (e.g., top, distal, upper end) of the outer member 242 of the linear actuator 240. The pivotable juncture 724 allows for sagittal plane pivoting about a first (1^{st}) rotational axis illustrated in FIGS. 7A and 7B. The pivotable juncture 726 allows for frontal plane pivoting about a second (2^{nd}) rotational axis illustrated in FIGS. 7A and 7B. In various embodiments, the upper juncture assembly 720 can be embodied and configured such that the lateral brace 722 is positioned at or approximately at and at least partly around a user's waist. In these embodiments, the upper juncture assembly 720 (e.g., the brace 723) can further be embodied and configured such that the pivotable juncture 724 is positioned at a location that is proximate or adjacent to the user's hip.

In the example shown, a link (e.g., the brace 723) between a sagittal plane joint (e.g., the pivotable juncture 724) and a frontal plane joint (e.g., the pivotable juncture 726) created by the exoskeleton 700 is angled upward (e.g., the created frontal plane joint is higher than the created sagittal plane joint). This may allow for the created sagittal plane joint to better align with user's hip joint. In some cases, the exoskeleton 700 can be embodied and configured such that the 1^{st} and 2^{nd} rotational axes intersect. In general, if a hinge for sagittal plane motion is co-located with a user's hip, this would avoid kinematic differences between that location and the hip location. Embodying and configuring the exoskeleton 700 such that the force vector is a little behind the user may help offset the weight of the exoskeleton 700 itself in some cases.

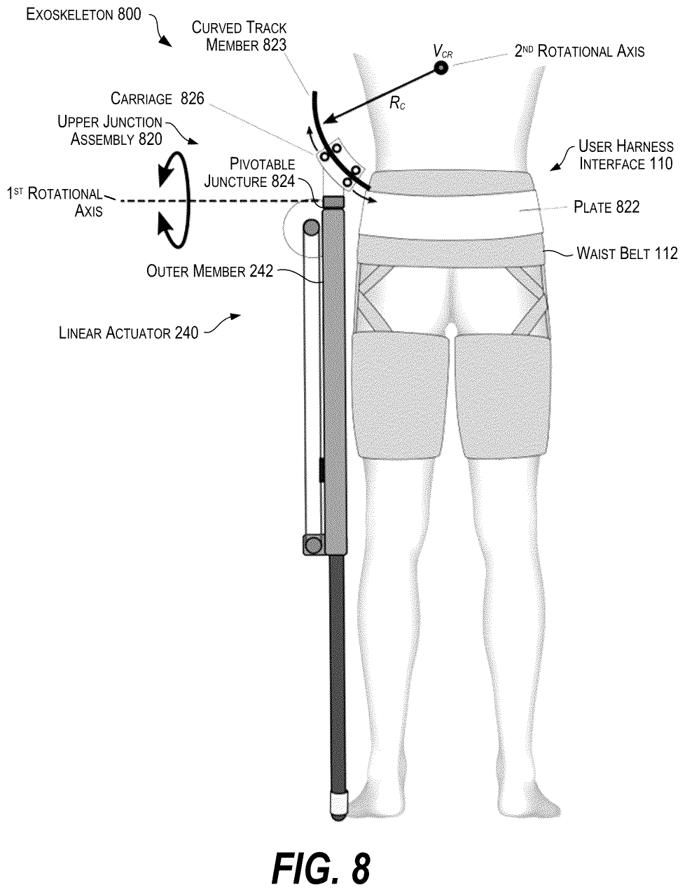

FIG. 8 illustrates a back view of another example exoskeleton 800 according to various aspects and embodiments of the present disclosure. The exoskeleton 800 can be designed, embodied, and implemented as a lower body exoskeleton according to different examples described herein. The exoskeleton 800 depicted in FIG. 8 is one illustrative example of an exoskeleton of the present disclosure. In other examples, the exoskeleton 800 can include one or more different or additional components compared to those shown in FIG. 8. In some examples, one or more components illustrated in FIG. 8 may be omitted from the exoskeleton 800. In some cases, one or more components of another exoskeleton embodiment described herein or illustrated in the figures may be included in the exoskeleton 800 in place of or in addition to one or more components shown in FIG. 8 to form a different embodiment of the exoskeleton 800. All such exoskeleton embodiment variations are envisioned and included within the scope of the present disclosure.

The exoskeleton 800 is an example alternative embodiment of the exoskeleton 700 described herein and illustrated in FIGS. 7A and 7B. For instance, the exoskeleton 800 can include the same or similar components, structure, materials, attributes, and functions as that of the exoskeleton 700. A difference between the exoskeleton 800 and the exoskeleton 700 is that the exoskeleton 800 includes a different user harness interface and a different upper juncture assembly compared to that of the exoskeleton 700. A lower juncture assembly and foot attachment interface are omitted from the example shown for clarity.

The exoskeleton 800 includes the user harness interface 110, an upper juncture assembly 820, and at least one linear actuator 240, among other components. Only a single linear actuator 240 is illustrated and denoted in FIG. 8 for clarity. In some embodiments, the exoskeleton 800 may include at least one of a different user harness interface, a different upper juncture assembly, a different and/or additional linear actuator, a different and/or additional lower juncture assembly, or a different and/or additional foot attachment interface compared to what is illustrated in FIG. 8.

The upper juncture assembly 820 of the exoskeleton 800 includes a plate 822, a curved track member 823, a pivotable juncture 824, and a carriage 826, among other components. The plate 822 is coupled to the waist belt 112 of the user harness interface 110. The plate 822 can be coupled to an outer surface of the waist belt 112 of the user harness interface 110 by way of, for instance, an adhesive, although another fastener may be used in some cases. The plate 822 can be embodied as at least one of a rigid, flexible, or curved material such as a metal band or plate, for instance, although another material may be used. In some examples, the plate 822 can be integrated in the waist belt 112, for instance, included in an inner lining of or otherwise positioned within the waist belt 112. The plate 822 can be embodied such that it extends at least partly or completely around a user's waist to transmit various forces directly to a user's center of body (e.g., center of mass) during implementation of the exoskeleton 800. For instance, the plate 822 can extend at least from a left-side region of a user's waist to a right-side region of the user's waist.

The curved track member 823 has a first end (e.g., bottom, distal, lower end) and a second end (e.g., top, distal, upper end) that is opposite the first end. The first end of the curved track member 823 is coupled to the plate 822 and the second end is free (e.g., uncoupled) in this example. The curved track member 823 extends from the plate 822 in a curving upward direction relative to the ground. The curved track member 823 is embodied and configured to be positioned in and move back and forth along a slot or channel of the carriage 826 for at least a portion of a length of the curved track member 823. For instance, the curved track member 823 can be positioned in and move back and forth along a slot or channel of the carriage 826 as a user moves their hip in abduction or adduction.

The pivotable juncture 824 is coupled to the first end (e.g., top, distal, upper end) of the outer member 242 of the linear actuator 240 and the carriage 826 is coupled to the pivotable juncture 824. In some embodiments, at least one of the pivotable juncture 824 or the carriage 826 may be a component of the linear actuator 240, for instance, either or both may be integrated into or otherwise coupled to an external surface of the outer member 242 at a location that is proximate or adjacent to the first end of the outer member 242. The carriage 826 is embodied and configured to travel (e.g., via wheels or rollers) along at least a portion of a length of the curved track member 823. For instance, the carriage 826 can travel along at least a portion of a length of the curved track member 823 as a user moves their hip in abduction or adduction.

The pivotable juncture 824 allows for sagittal plane pivoting about a first (1^{st}) rotational axis illustrated in FIG. 8. The plate 822, the curved track member 823, and the carriage 826 collectively allow for the carriage 826 to travel along the curved track member 823 to facilitate pivoting about a second (2^{nd}) rotational axis illustrated in FIG. 8. The curved track member 823 has a radius of curvature (R_{c}) relative to the 2^{nd} rotational axis illustrated in FIG. 8.

In the example shown, the exoskeleton 800 is an example alternative to an exoskeleton having a discrete pivot point for frontal plane motion. The exoskeleton 800 includes the curved track member 823 attached to the waist belt 112, and the carriage 826 riding on the curved track member 823. As a user moves their hip in abduction or adduction, the carriage 826 moves along the curved track member 823. The arrangement of the upper junction assembly 820 in the example shown allows a front and back of a user's body to be free from moving linkages. Additionally, this allows a virtual center of rotation (V_{cr}) about the 2^{nd} rotational axis, which is higher on a user's body than the waist belt 112. This can be useful for creating stability when a supported center of mass is lower than the virtual center of rotation (V_{cr}).

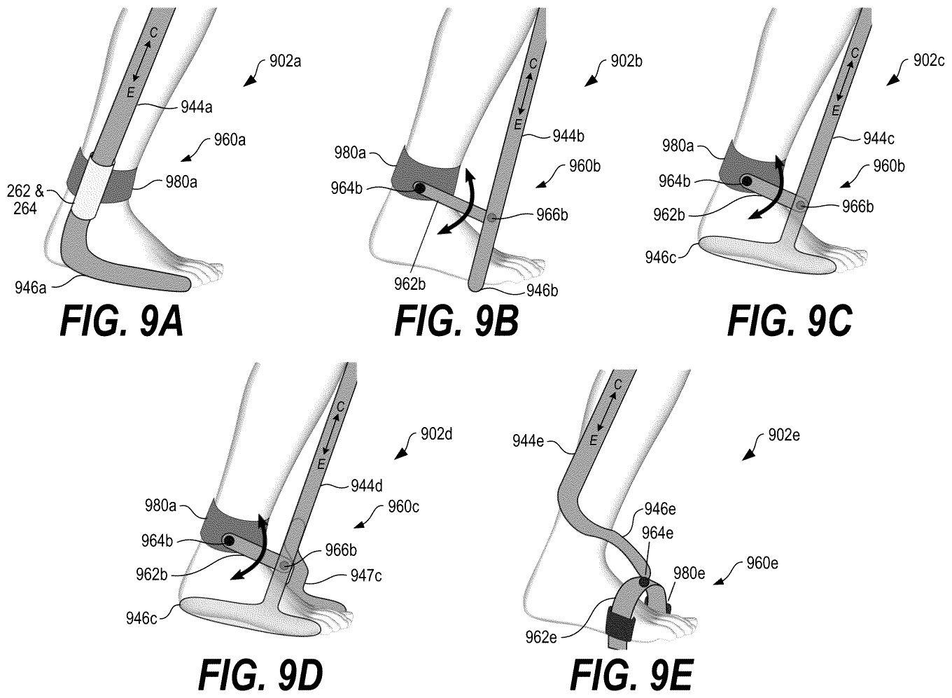

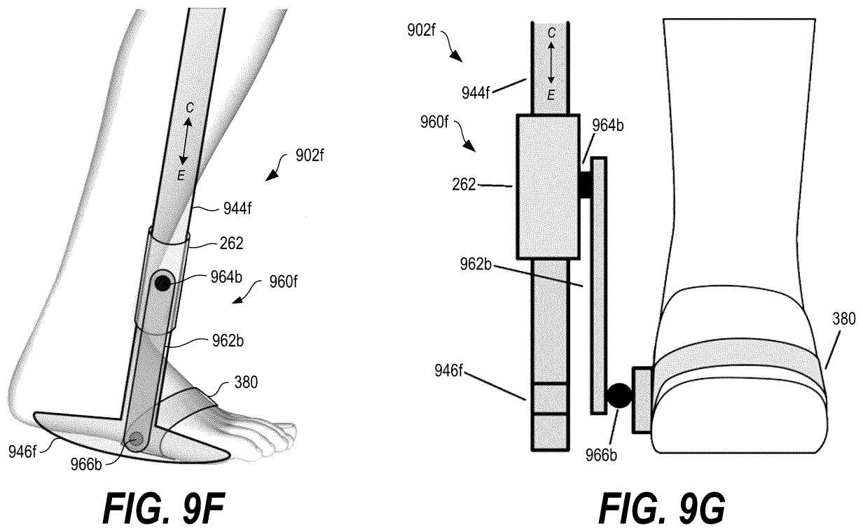

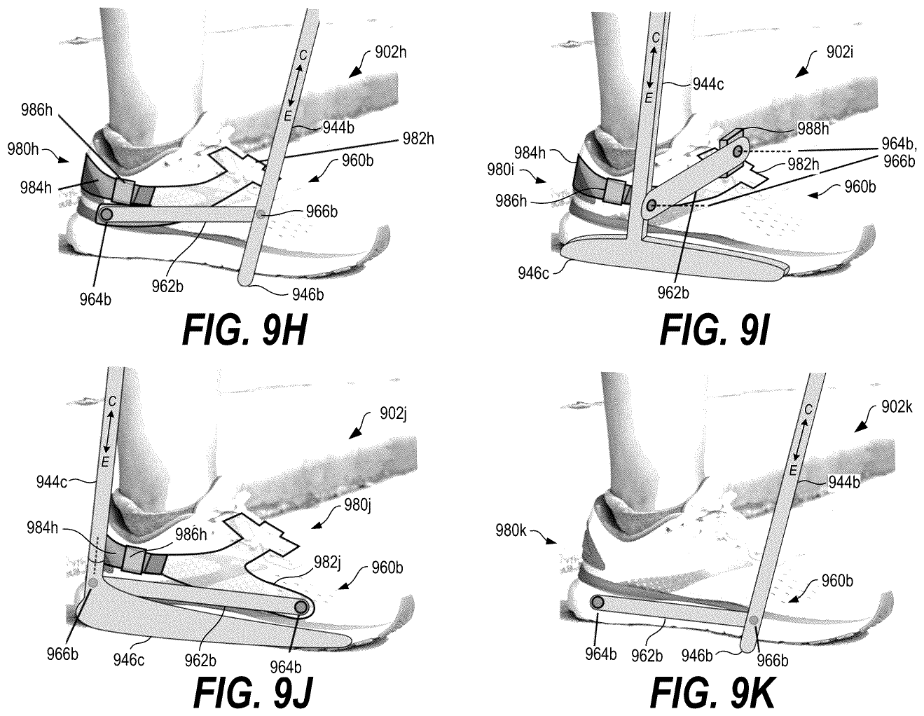

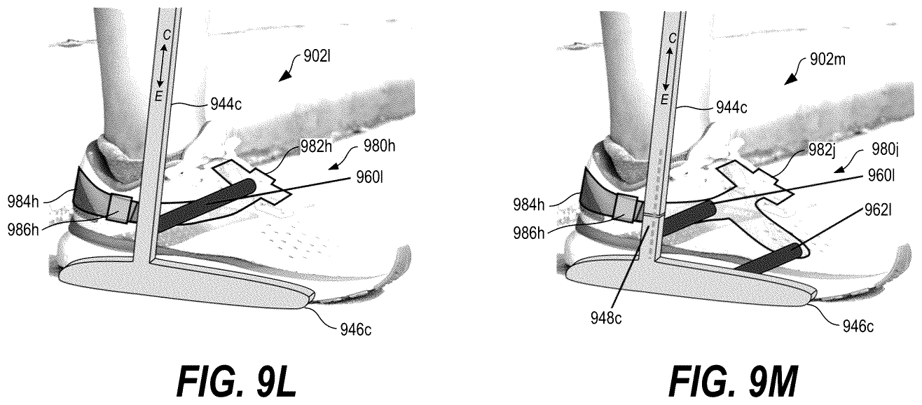

FIG. 9A illustrates a perspective view of an example exoskeleton lower end 902a according to various aspects and embodiments of the present disclosure. The exoskeleton lower end 902a can be designed, embodied, and implemented as a lower portion of a lower body exoskeleton according to different examples described herein. For instance, the exoskeleton lower end 902a can be designed, embodied, and implemented as a lower portion of any exoskeleton embodiment described herein or another exoskeleton. The exoskeleton lower end 902a can be embodied and configured to be at least one of proximate or adjacent to a user's foot, coupled to the user's ankle or foot region, at least partly in contact with the ground, or at least periodically in contact with the ground.

The exoskeleton lower end 902a depicted in FIG. 9A is one illustrative example of an exoskeleton lower end of the present disclosure. In other examples, the exoskeleton lower end 902a can include one or more different or additional components compared to those shown in FIG. 9A. In some examples, one or more components illustrated in FIG. 9A may be omitted from the exoskeleton lower end 902a. In some cases, one or more components of another exoskeleton lower end embodiment described herein or illustrated in the figures may be included in the exoskeleton lower end 902a in place of or in addition to one or more components shown in FIG. 9A to form a different embodiment of the exoskeleton lower end 902a. All such exoskeleton lower end embodiment variations are envisioned and included within the scope of the present disclosure.

The exoskeleton lower end 902a includes a lower member 944a of an exoskeleton actuator (e.g., the linear actuator 240, not illustrated), a lower juncture assembly 960a, and a foot attachment interface 980a. The lower member 944a includes an actuator end 946a located approximately at a bottom, distal, or lower end of the lower member 944a. The lower juncture assembly 960a includes the positioning member 262 and the pivotable juncture 264 coupled to the foot attachment interface 980a. In the example shown, the foot attachment interface 980a is embodied as an ankle harness interface, although another type of foot attachment interface may be used in some cases. The foot attachment interface 980a can be embodied as at least one of a rigid or a flexible material that can extend partly or completely around a user's ankle region.

In the example shown, the lower member 944a is embodied as a cylinder or tube having a circular or annular-shaped cross-section and the positioning member 262 is embodied and configured as a tube that can receive such a cylinder or tube-shaped lower member 944a. In other examples, the lower member 944a can be embodied to have another geometry or cross-sectional shape such as, for instance, a triangular-shaped cross section, a square-shaped cross-section, a rectangular-shaped cross-section, or another cross-sectional shape. In these examples, the positioning member 262 can be embodied and configured to receive such a lower member 944a having any of such cross-sectional shapes. The lower member 944a is embodied and configured in the example shown to travel back (e.g., contraction) and forth (e.g., extension) through the positioning member 262. The lower member 944a and the actuator end 946a are collectively embodied and configured to raise (e.g., away from the ground) the actuator end 946a during contraction (C) and to lower (e.g., toward the ground) the actuator end 946a during extension (E), for instance, as illustrated in FIG. 9A. The actuator end 946a can be embodied and configured to be at least one of proximate or adjacent to a user's foot, at least partly in contact with the ground, or at least periodically in contact with the ground (e.g., during a gait cycle). For instance, the actuator end 946a can be embodied and configured as a type of ground contact platform or exoskeleton “foot” that can be positioned adjacent to an outer portion of a user's foot during implementation and be at least one of partly, entirely, or periodically in contact with the ground during a gait cycle. In the example shown, the lower member 944a and the actuator end 946a are formed as a single component (e.g., continuous, contiguous). In other embodiments, the lower member 944a and the actuator end 946a may be embodied as separate components that can be coupled together to form the same or similar lower member 944a and actuator end 946a structure illustrated in FIG. 9A. In one example, at least one of the lower member 944a or the actuator end 946a can include a carbon fiber material, although another material may be used in some cases.

The positioning member 262 and the pivotable juncture 264 can be coupled to a side of the foot attachment interface 980a. In the example shown, the positioning member 262 and the pivotable juncture 264 are coupled to an outer side of the foot attachment interface 980a that corresponds to an outer side of a foot of a user wearing the exoskeleton lower end 902a. The pivotable juncture 264 can be embodied as a ball joint that is coupled to the positioning member 262 and the foot attachment interface 980a. The ball joint can be coupled to the positioning member 262 and the foot attachment interface 980a in a manner that allows the foot attachment interface 980a to have at least one degree of freedom (e.g., at least one rotational degree of freedom) relative to at least one of the positioning member 262, the lower member 944a, or the actuator end 946a. In one example, a portion of the ball joint can be integrated into or coupled to an external surface of the positioning member 262 and another portion of the ball joint can be positioned within a slot or channel of the foot attachment interface 980a such that the foot attachment interface 980a can rotate about the ball joint relative to at least one of the positioning member 262, the lower member 944a, or the actuator end 946a. For example, as forces described herein are applied to the lower member 944a to cause the lower member 944a to slide in (e.g., contraction) and out (e.g., extension) of the positioning member 262, the foot attachment interface 980a can rotate about the ball joint in at least one degree of freedom relative to at least one of the positioning member 262, the lower member 944a, or the actuator end 946a. In the example shown, the positioning member 262, the lower member 944a, and the actuator end 946a are collectively embodied and configured such that the lower member 944a and the actuator end 946a can rotate about an axis of the lower member 944a while the lower member 944a slides back and forth inside the positioning member 262.

FIG. 9B illustrates a perspective view of another example exoskeleton lower end 902b according to various aspects and embodiments of the present disclosure. The exoskeleton lower end 902b can be designed, embodied, and implemented as a lower portion of a lower body exoskeleton according to different examples described herein. For instance, the exoskeleton lower end 902b can be designed, embodied, and implemented as a lower portion of any exoskeleton embodiment described herein or another exoskeleton. The exoskeleton lower end 902b can be embodied and configured to be at least one of proximate or adjacent to a user's foot, coupled to the user's ankle or foot region, at least partly in contact with the ground, or at least periodically in contact with the ground.

The exoskeleton lower end 902b depicted in FIG. 9B is one illustrative example of an exoskeleton lower end of the present disclosure. In other examples, the exoskeleton lower end 902b can include one or more different or additional components compared to those shown in FIG. 9B. In some examples, one or more components illustrated in FIG. 9B may be omitted from the exoskeleton lower end 902b. In some cases, one or more components of another exoskeleton lower end embodiment described herein or illustrated in the figures may be included in the exoskeleton lower end 902b in place of or in addition to one or more components shown in FIG. 9B to form a different embodiment of the exoskeleton lower end 902b. All such exoskeleton lower end embodiment variations are envisioned and included within the scope of the present disclosure.

The exoskeleton lower end 902b is an example alternative embodiment of the exoskeleton lower end 902a described herein and illustrated in FIG. 9A. For instance, the exoskeleton lower end 902b can include the same or similar components, structure, materials, attributes, and functions as that of the exoskeleton lower end 902a. A difference between the exoskeleton lower end 902b and the exoskeleton lower end 902a is that the exoskeleton lower end 902b includes a different actuator end and a different lower juncture assembly compared to that of the exoskeleton lower end 902a.

The exoskeleton lower end 902b includes a lower member 944b of an exoskeleton actuator (e.g., the linear actuator 240, not illustrated), a lower juncture assembly 960b, and the foot attachment interface 980a. The lower member 944b includes an actuator end 946b located approximately at a bottom, distal, or lower end of the lower member 944b. The lower juncture assembly 960b includes a rocker bar 962b having a first end that is coupled to the foot attachment interface 980a and a second end that is coupled to the lower member 944b. In the example shown, the first end of the rocker bar 962b is coupled to the foot attachment interface 980a by way of a first pivotable juncture 964b and the second end of the rocker bar 962b is coupled to the lower member 944b by way of a second pivotable juncture 966b.

The lower member 944b and the actuator end 946b are collectively embodied and configured to raise (e.g., away from the ground) the actuator end 946b during contraction (C) and to lower (e.g., toward the ground) the actuator end 946b during extension (E), for instance, as illustrated in FIG. 9B. The actuator end 946b can be embodied and configured to be at least one of proximate or adjacent to a user's foot, at least partly in contact with the ground, or at least periodically in contact with the ground (e.g., during a gait cycle). For instance, the actuator end 946b can be embodied and configured to be positioned adjacent to an outer portion of a user's foot during implementation and be at least one of partly, entirely, or periodically in contact with the ground during a gait cycle. In one example, at least one of the lower member 944a or the actuator end 946a can include a carbon fiber material, although another material may be used in some cases.

The rocker bar 962b and the pivotable juncture 964b can be coupled to a side of the foot attachment interface 980a. In the example shown, the rocker bar 962b and the pivotable juncture 964b are coupled to an outer side of the foot attachment interface 980a that corresponds to an outer side of a foot of a user wearing the exoskeleton lower end 902a. The pivotable juncture 964b can be embodied as a pin joint that is coupled to the first end of the rocker bar 962b and to the foot attachment interface 980a. The pin joint can be coupled to the rocker bar 962b and the foot attachment interface 980a in a manner that allows the foot attachment interface 980a to have at least one degree of freedom (e.g., at least one rotational degree of freedom) relative to at least one of the rocker bar 962b or the lower member 944b. For example, as forces described herein are applied to the lower member 944b to cause it to contract and extend, the foot attachment interface 980a can rotate about the pin joint in at least one degree of freedom relative to at least one of the rocker bar 962b or the lower member 944b. The pivotable juncture 966b can be embodied as a ball joint coupled to the second end of the rocker bar 962b and to the lower member 944b. Alternatively, the pivotable juncture 966b can be embodied as a pin joint and the pivotable juncture 964b can be embodied as a ball joint.

FIG. 9C illustrates a perspective view of another example exoskeleton lower end 902c according to various aspects and embodiments of the present disclosure. The exoskeleton lower end 902c can be designed, embodied, and implemented as a lower portion of a lower body exoskeleton according to different examples described herein. For instance, the exoskeleton lower end 902c can be designed, embodied, and implemented as a lower portion of any exoskeleton embodiment described herein or another exoskeleton. The exoskeleton lower end 902c can be embodied and configured to be at least one of proximate or adjacent to a user's foot, coupled to the user's ankle or foot region, at least partly in contact with the ground, or at least periodically in contact with the ground.

The exoskeleton lower end 902c depicted in FIG. 9C is one illustrative example of an exoskeleton lower end of the present disclosure. In other examples, the exoskeleton lower end 902c can include one or more different or additional components compared to those shown in FIG. 9C. In some examples, one or more components illustrated in FIG. 9C may be omitted from the exoskeleton lower end 902c. In some cases, one or more components of another exoskeleton lower end embodiment described herein or illustrated in the figures may be included in the exoskeleton lower end 902c in place of or in addition to one or more components shown in FIG. 9C to form a different embodiment of the exoskeleton lower end 902c. All such exoskeleton lower end embodiment variations are envisioned and included within the scope of the present disclosure.

The exoskeleton lower end 902c is an example alternative embodiment of the exoskeleton lower end 902b described herein and illustrated in FIG. 9B. For instance, the exoskeleton lower end 902c can include the same or similar components, structure, materials, attributes, and functions as that of the exoskeleton lower end 902b. A difference between the exoskeleton lower end 902c and the exoskeleton lower end 902b is that the exoskeleton lower end 902c includes a different actuator end compared to that of the exoskeleton lower end 902b.

The exoskeleton lower end 902c includes a lower member 944c of an exoskeleton actuator (e.g., the linear actuator 240, not illustrated), the lower juncture assembly 960b, and the foot attachment interface 980a. The lower member 944c includes an actuator end 946c located approximately at a bottom, distal, or lower end of the lower member 944c.

The lower member 944c and the actuator end 946c are collectively embodied and configured to raise (e.g., away from the ground) the actuator end 946c during contraction (C) and to lower (e.g., toward the ground) the actuator end 946c during extension (E), for instance, as illustrated in FIG. 9C. The actuator end 946c can be embodied and configured to be at least one of proximate or adjacent to a user's foot, at least partly in contact with the ground, or at least periodically in contact with the ground (e.g., during a gait cycle). For instance, the actuator end 946c can be embodied and configured as a type of ground contact platform or exoskeleton “foot” that can be positioned adjacent to an outer portion of a user's foot during implementation and be at least one of partly, entirely, or periodically in contact with the ground during a gait cycle. In the example shown, the lower member 944c and the actuator end 946c are formed as a single component (e.g., continuous, contiguous). In other embodiments, the lower member 944c and the actuator end 946c may be embodied as separate components that can be coupled together to form the same or similar lower member 944c and actuator end 946c structure illustrated in FIG. 9C. In one example, at least one of the lower member 944c or the actuator end 946c can include a carbon fiber material, although another material may be used in some cases.

FIG. 9D illustrates a perspective view of another example exoskeleton lower end 902d according to various aspects and embodiments of the present disclosure. The exoskeleton lower end 902d can be designed, embodied, and implemented as a lower portion of a lower body exoskeleton according to different examples described herein. For instance, the exoskeleton lower end 902d can be designed, embodied, and implemented as a lower portion of any exoskeleton embodiment described herein or another exoskeleton. The exoskeleton lower end 902d can be embodied and configured to be at least one of proximate or adjacent to a user's foot, coupled to the user's ankle or foot region, at least partly in contact with the ground, or at least periodically in contact with the ground.

The exoskeleton lower end 902d depicted in FIG. 9D is one illustrative example of an exoskeleton lower end of the present disclosure. In other examples, the exoskeleton lower end 902d can include one or more different or additional components compared to those shown in FIG. 9D. In some examples, one or more components illustrated in FIG. 9D may be omitted from the exoskeleton lower end 902d. In some cases, one or more components of another exoskeleton lower end embodiment described herein or illustrated in the figures may be included in the exoskeleton lower end 902d in place of or in addition to one or more components shown in FIG. 9D to form a different embodiment of the exoskeleton lower end 902d. All such exoskeleton lower end embodiment variations are envisioned and included within the scope of the present disclosure.

The exoskeleton lower end 902d is an example alternative embodiment of the exoskeleton lower end 902c described herein and illustrated in FIG. 9C. For instance, the exoskeleton lower end 902d can include the same or similar components, structure, materials, attributes, and functions as that of the exoskeleton lower end 902c. A difference between the exoskeleton lower end 902d and the exoskeleton lower end 902c is that the exoskeleton lower end 902d includes an additional actuator end compared to that of the exoskeleton lower end 902c.

The exoskeleton lower end 902d includes a lower member 944d of an exoskeleton actuator (e.g., the linear actuator 240, not illustrated), the lower juncture assembly 960b, and the foot attachment interface 980a. The lower member 944d includes the actuator end 946c and an additional actuator end 947c located approximately at a bottom, distal, or lower end of the lower member 944d. The actuator end 946c and the actuator end 947c are coupled to one another and configured to move as a single unit. An axis of rotation extending along the lower member 944d in the example is located above the rocker bar 962b or proximate a user's hip.

The lower member 944d, the actuator end 946c, and the actuator end 947c are collectively embodied and configured to raise (e.g., away from the ground) the actuator ends 946c, 947c during contraction (C) and to lower (e.g., toward the ground) the actuator ends 946c, 947c during extension (E), for instance, as illustrated in FIG. 9D. The actuator ends 946c, 947c can each be embodied and configured to be at least one of proximate or adjacent to a user's foot, at least partly in contact with the ground, or at least periodically in contact with the ground (e.g., during a gait cycle). For instance, the actuator end 946c can be embodied and configured as a type of ground contact platform or exoskeleton “foot” that can be positioned adjacent to an outer portion of a user's foot during implementation and be at least one of partly, entirely, or periodically in contact with the ground during a gait cycle. In this example, the actuator end 947c can be embodied and configured as a type of ground contact platform or exoskeleton “foot” that can be positioned adjacent to an inner portion of a user's foot during implementation and be at least one of partly, entirely, or periodically in contact with the ground during a gait cycle. In some embodiments, the actuator ends 946c, 947c can be formed as a single component (e.g., continuous, contiguous). In other embodiments, the actuator ends 946c, 947c may be embodied as separate components that can be coupled together to form the same or similar lower member 944d and actuator ends 946c, 947c structure illustrated in FIG. 9D. In one example, at least one of the lower member 944d, the actuator end 946c, or the actuator end 947c can include a carbon fiber material, although another material may be used in some cases.

FIG. 9E illustrates a perspective view of another example exoskeleton lower end 902e according to various aspects and embodiments of the present disclosure. The exoskeleton lower end 902e can be designed, embodied, and implemented as a lower portion of a lower body exoskeleton according to different examples described herein. For instance, the exoskeleton lower end 902e can be designed, embodied, and implemented as a lower portion of any exoskeleton embodiment described herein or another exoskeleton. The exoskeleton lower end 902e can be embodied and configured to be at least one of proximate or adjacent to a user's foot, coupled to the user's foot, at least partly in contact with the ground, or at least periodically in contact with the ground.

The exoskeleton lower end 902e depicted in FIG. 9E is one illustrative example of an exoskeleton lower end of the present disclosure. In other examples, the exoskeleton lower end 902e can include one or more different or additional components compared to those shown in FIG. 9E. In some examples, one or more components illustrated in FIG. 9E may be omitted from the exoskeleton lower end 902e. In some cases, one or more components of another exoskeleton lower end embodiment described herein or illustrated in the figures may be included in the exoskeleton lower end 902e in place of or in addition to one or more components shown in FIG. 9E to form a different embodiment of the exoskeleton lower end 902e. All such exoskeleton lower end embodiment variations are envisioned and included within the scope of the present disclosure.

The exoskeleton lower end 902e includes a lower member 944e of an exoskeleton actuator (e.g., the linear actuator 240, not illustrated), a lower juncture assembly 960e, and a foot attachment interface 980e. The lower member 944e includes an actuator end 946e located approximately at a bottom, distal, or lower end of the lower member 944e. The lower juncture assembly 960e includes a pivotable member 962e and a pivotable juncture 964e. The pivotable member 962e is coupled to the actuator end 946e by way of the pivotable juncture 964e. In the example shown, a top portion of the pivotable member 962e that corresponds to a top of a user's foot is coupled to the actuator end 946e by way of the pivotable juncture 964e. In another example, a side portion of the pivotable member 962e that corresponds to an inside or an outside of a user's foot is coupled to the actuator end 946e by way of the pivotable juncture 964e. The pivotable member 962e is embodied to have a curved shape in the example shown, although another shape may be relied upon in some cases. In one example, the pivotable juncture 964e can be embodied as a ball joint. In another example, the foot attachment interface 980e can be embodied as a shoe and the pivotable member 962e may be integrated into, embedded in, or otherwise coupled to the shoe. For instance, the pivotable member 962e can be integrated into, embedded in, or otherwise coupled to the shoe at a location that is at least one of proximate or adjacent to the ball of a user's foot.

In the example shown, the foot attachment interface 980e is embodied as a foot harness interface (e.g., a foot strap) that is coupled at two locations to the pivotable member 962e, although another type of foot attachment interface may be used in some cases. In this example, the foot attachment interface 980e is coupled at two locations to the pivotable member 962e to create a sliding joint. The foot attachment interface 980e can be embodied as at least one of a rigid or a flexible material that can extend partly or completely around a user's ankle region.

The lower member 944e, the actuator end 946e, the pivotable member 962e are collectively embodied and configured to raise (e.g., away from the ground) the pivotable member 962e during contraction (C) and to lower (e.g., toward the ground) the pivotable member 962e during extension (E), for instance, as illustrated in FIG. 9E. The pivotable member 962e can be embodied and configured to be at least one of proximate or adjacent to (e.g., around) a user's foot, at least partly in contact with the ground, or at least periodically in contact with the ground (e.g., during a gait cycle). For instance, the pivotable member 962e can be embodied and configured as a type of ground contact platform or exoskeleton “foot” that can be positioned adjacent to or around a front portion of a user's foot during implementation and be at least one of partly, entirely, or periodically in contact with the ground during a gait cycle. In the example shown, the lower member 944e and the actuator end 946e are formed as a single component (e.g., continuous, contiguous). In other embodiments, the lower member 944e and the actuator end 946e may be embodied as separate components that can be coupled together to form the same or similar lower member 944e and actuator end 946e structure illustrated in FIG. 9A. In one example, at least one of the lower member 944e or the actuator end 946e can include a carbon fiber material, although another material may be used in some cases.

The pivotable juncture 964e can be embodied as a ball joint that is coupled to the pivotable member 962e and the actuator end 946e in a manner that allows the pivotable member 962e to have at least one degree of freedom (e.g., at least one rotational degree of freedom) relative to at least one of the lower member 944e or the actuator end 946e. For example, as forces described herein are applied to the lower member 944e to cause the lower member 944e to contract and extend, the pivotable member 962e can rotate about the ball joint in at least one degree of freedom relative to at least one of the lower member 944e or the actuator end 946e.

FIG. 9F illustrates a perspective view of another example exoskeleton lower end 902f according to various aspects and embodiments of the present disclosure. FIG. 9G illustrates a front view of the example exoskeleton lower end 902f according to various aspects and embodiments of the present disclosure. The exoskeleton lower end 902f can be designed, embodied, and implemented as a lower portion of a lower body exoskeleton according to different examples described herein. For instance, the exoskeleton lower end 902f can be designed, embodied, and implemented as a lower portion of any exoskeleton embodiment described herein or another exoskeleton. The exoskeleton lower end 902f can be embodied and configured to be at least one of proximate or adjacent to a user's foot, coupled to the user's foot, at least partly in contact with the ground, or at least periodically in contact with the ground.

The exoskeleton lower end 902f depicted in FIGS. 9F and 9G is one illustrative example of an exoskeleton lower end of the present disclosure. In other examples, the exoskeleton lower end 902f can include one or more different or additional components compared to those shown in FIGS. 9F and 9G. In some examples, one or more components illustrated in FIG. 9F or 9G may be omitted from the exoskeleton lower end 902f. In some cases, one or more components of another exoskeleton lower end embodiment described herein or illustrated in the figures may be included in the exoskeleton lower end 902f in place of or in addition to one or more components shown in FIG. 9F or 9G to form a different embodiment of the exoskeleton lower end 902f. All such exoskeleton lower end embodiment variations are envisioned and included within the scope of the present disclosure.

The exoskeleton lower end 902f is an example alternative embodiment of the exoskeleton lower end 902c described herein and illustrated in FIG. 9C. For instance, the exoskeleton lower end 902f can include the same or similar components, structure, materials, attributes, and functions as that of the exoskeleton lower end 902c. A difference between the exoskeleton lower end 902f and the exoskeleton lower end 902c is that the exoskeleton lower end 902f includes a different actuator end, a different lower juncture assembly, and a different foot attachment assembly compared to that of the exoskeleton lower end 902c.

The exoskeleton lower end 902f includes a lower member 944f of an exoskeleton actuator (e.g., the linear actuator 240, not illustrated), a lower juncture assembly 960f, and the foot attachment interface 380. The lower member 944f includes an actuator end 946f located approximately at a bottom, distal, or lower end of the lower member 944f.

The lower juncture assembly 960f includes the rocker bar 962b with its first end coupled to the foot attachment interface 380 and its second end coupled to the positioning member 262. In the example shown, the first end of the rocker bar 962b is coupled to the foot attachment interface 380 by way of the pivotable juncture 966b and the second end of the rocker bar 962b is coupled to the positioning member 262 by way of the pivotable juncture 964b.

The rocker bar 962b and the pivotable juncture 964b can be coupled to a side of the positioning member 262. In the example shown, the rocker bar 962b and the pivotable juncture 964b are coupled to an inner side of the positioning member 262 that corresponds to an outer side of a foot of a user wearing the exoskeleton lower end 902f. The pivotable juncture 964b can be embodied as a pin joint coupled to the second end of the rocker bar 962b and to the positioning member 262. The pin joint can be coupled to the positioning member 262 and to the rocker bar 962b in a manner that allows the rocker bar 962b and the foot attachment interface 380 to have at least one degree of freedom (e.g., at least one rotational degree of freedom) relative to at least one of the positioning member 262, the lower member 944f, or the actuator end 946f. For example, as forces described herein are applied to the lower member 944f to cause it to contract (C) and extend (E), the rocker bar 962b and the foot attachment interface 380 can rotate about the pin joint in at least one degree of freedom relative to at least one of the positioning member 262, the lower member 944f, or the actuator end 946f. In one embodiment, the lower juncture assembly 960f can further include a spring that can be coupled to at least one of the positioning member 262, the rocker bar 962b, or the pivotable juncture 964b in a manner that allows the lower juncture assembly 960f to maintain the rocker bar 962b approximately nominally parallel to the lower member 944f.

The rocker bar 962b and the pivotable juncture 966b can be coupled to a side of the foot attachment interface 380. In the example shown, the rocker bar 962b and the pivotable juncture 966b are coupled to an outer side of the foot attachment interface 380 that corresponds to an outer side of a foot of a user wearing the exoskeleton lower end 902f. The pivotable juncture 966b can be embodied as a ball joint that is coupled to the first end of the rocker bar 962b and to the foot attachment interface 380. The ball joint can be coupled to the rocker bar 962b and the foot attachment interface 380 in a manner that allows the foot attachment interface 380 to have at least one degree of freedom (e.g., at least one rotational degree of freedom) relative to at least one of the rocker bar 962b, the positioning member 262, the lower member 944f, or the actuator end 946f. For example, as forces described herein are applied to the lower member 944f to cause it to contract (C) and extend (E), the foot attachment interface 380 can rotate about the ball joint in at least one degree of freedom relative to at least one of the rocker bar 962b, the positioning member 262, the lower member 944f, or the actuator end 946f.

The lower member 944f is embodied and configured in the example shown to travel back (e.g., contraction) and forth (e.g., extension) through the positioning member 262. The lower member 944f and the actuator end 946f are collectively embodied and configured to raise (e.g., away from the ground) the actuator end 946f during contraction (C) and to lower (e.g., toward the ground) the actuator end 946f during extension (E), for instance, as illustrated in FIGS. 9F and 9G. The actuator end 946f can be embodied and configured to be at least one of proximate or adjacent to a user's foot, at least partly in contact with the ground, or at least periodically in contact with the ground (e.g., during a gait cycle). For instance, the actuator end 946f can be embodied and configured as a type of ground contact platform or exoskeleton “foot” that can be positioned adjacent to an outer portion of a user's foot during implementation and be at least one of partly, entirely, or periodically in contact with the ground during a gait cycle. In the example shown, the lower member 944f and the actuator end 946f are formed as a single component (e.g., continuous, contiguous). In other embodiments, the lower member 944f and the actuator end 946f may be embodied as separate components that can be coupled together to form the same or similar lower member 944f and actuator end 946f structure illustrated in FIGS. 9F and 9G. In one example, at least one of the lower member 944f or the actuator end 946f can include a carbon fiber material, although another material may be used in some cases.

FIG. 9H illustrates a perspective view of another example exoskeleton lower end 902h according to various aspects and embodiments of the present disclosure. The exoskeleton lower end 902h can be designed, embodied, and implemented as a lower portion of a lower body exoskeleton according to different examples described herein. For instance, the exoskeleton lower end 902h can be designed, embodied, and implemented as a lower portion of any exoskeleton embodiment described herein or another exoskeleton. The exoskeleton lower end 902h can be embodied and configured to be at least one of proximate or adjacent to a user's foot, coupled to the user's ankle or foot region, at least partly in contact with the ground, or at least periodically in contact with the ground.

The exoskeleton lower end 902h depicted in FIG. 9H is one illustrative example of an exoskeleton lower end of the present disclosure. In other examples, the exoskeleton lower end 902h can include one or more different or additional components compared to those shown in FIG. 9H. In some examples, one or more components illustrated in FIG. 9H may be omitted from the exoskeleton lower end 902h. In some cases, one or more components of another exoskeleton lower end embodiment described herein or illustrated in the figures may be included in the exoskeleton lower end 902h in place of or in addition to one or more components shown in FIG. 9H to form a different embodiment of the exoskeleton lower end 902h. All such exoskeleton lower end embodiment variations are envisioned and included within the scope of the present disclosure.

The exoskeleton lower end 902h is an example alternative embodiment of the exoskeleton lower end 902b described herein and illustrated in FIG. 9B. For instance, the exoskeleton lower end 902h can include the same or similar components, structure, materials, attributes, and functions as that of the exoskeleton lower end 902b. A difference between the exoskeleton lower end 902h and the exoskeleton lower end 902b is that the exoskeleton lower end 902h includes a different foot attachment interface compared to that of the exoskeleton lower end 902b.

The exoskeleton lower end 902h includes the lower member 944b of an exoskeleton actuator (e.g., the linear actuator 240, not illustrated), the lower juncture assembly 960b, and a foot attachment interface 980h. The foot attachment interface 980h includes a rigid member 982h, a flexible member 984h, and an adjustment component 986h, among other components. The rigid member 982h can be embodied as a piece of sheet metal configured for coupling with a shoe or other foot cover. For instance, the rigid member 982h can be embodied as a piece of sheet metal having holes that allow shoelaces of a shoe to be threaded through to couple the rigid member 982h to the shoe. The flexible member 984h can be embodied as a webbing or fabric that can be coupled to a back portion of a shoe or other foot cover. The rigid member 982h and the flexible member 984h are coupled to one another and together extend at least partly around a user's ankle or foot. The adjustment component 986h can be embodied as a buckle for webbing or fabric that can be used to adjust the foot attachment interface 980h to different sizes of shoe and to fasten the foot attachment interface 980h to a shoe or other foot cover. The pivotable juncture 964b in the example shown can be embodied as a hinge joint. In some embodiments, the lower juncture assembly 960b of the exoskeleton lower end 902h can further include an encoder or a distance sensor positioned at or approximately at location of the pivotable juncture 964b to monitor how the lower member 944b is raised or lowered relative to a user's foot.

FIG. 9I illustrates a perspective view of another example exoskeleton lower end 902i according to various aspects and embodiments of the present disclosure. The exoskeleton lower end 902i can be designed, embodied, and implemented as a lower portion of a lower body exoskeleton according to different examples described herein. For instance, the exoskeleton lower end 902i can be designed, embodied, and implemented as a lower portion of any exoskeleton embodiment described herein or another exoskeleton. The exoskeleton lower end 902i can be embodied and configured to be at least one of proximate or adjacent to a user's foot, coupled to the user's ankle or foot region, at least partly in contact with the ground, or at least periodically in contact with the ground.

The exoskeleton lower end 902i depicted in FIG. 9I is one illustrative example of an exoskeleton lower end of the present disclosure. In other examples, the exoskeleton lower end 902i can include one or more different or additional components compared to those shown in FIG. 9I. In some examples, one or more components illustrated in FIG. 9I may be omitted from the exoskeleton lower end 902i. In some cases, one or more components of another exoskeleton lower end embodiment described herein or illustrated in the figures may be included in the exoskeleton lower end 902i in place of or in addition to one or more components shown in FIG. 9I to form a different embodiment of the exoskeleton lower end 902i. All such exoskeleton lower end embodiment variations are envisioned and included within the scope of the present disclosure.

The exoskeleton lower end 902i is an example alternative embodiment of the exoskeleton lower end 902h described herein and illustrated in FIG. 9H. For instance, the exoskeleton lower end 902i can include the same or similar components, structure, materials, attributes, and functions as that of the exoskeleton lower end 902h. A difference between the exoskeleton lower end 902i and the exoskeleton lower end 902h is that the exoskeleton lower end 902i includes a different actuator end and a different foot attachment interface compared to that of the exoskeleton lower end 902h.

The exoskeleton lower end 902i includes the lower member 944c of an exoskeleton actuator (e.g., the linear actuator 240, not illustrated), the lower juncture assembly 960b, and a foot attachment interface 980i. The foot attachment interface 980i includes the rigid member 982h, the flexible member 984h, the adjustment component 986h, and a bracket 988h, among other components. The bracket 988h can be embodied as a rigid material coupled to a top portion of the rigid member 982h and to the first end of the rocker bar 962b. In the example shown, the rocker bar 962b is coupled at its first end to a top portion of the rigid member 982h and further coupled at its second end to a location on the lower member 944c that is proximate or adjacent to the actuator end 946c. In this example, the rocker bar 962b extends in a horizontal or lateral direction (e.g., approximately parallel to the ground) between the bracket 988h and the lower member 944c. In this example, at least one of the pivotable juncture 964b or the pivotable juncture 966b can be embodied as a ball joint. In some embodiments, the rocker bar 962b may be embodied as a four-bar linkage (e.g., the four-bar linkage 548 or similar).

FIG. 9J illustrates a perspective view of another example exoskeleton lower end 902j according to various aspects and embodiments of the present disclosure. The exoskeleton lower end 902j can be designed, embodied, and implemented as a lower portion of a lower body exoskeleton according to different examples described herein. For instance, the exoskeleton lower end 902j can be designed, embodied, and implemented as a lower portion of any exoskeleton embodiment described herein or another exoskeleton. The exoskeleton lower end 902j can be embodied and configured to be at least one of proximate or adjacent to a user's foot, coupled to the user's ankle or foot region, at least partly in contact with the ground, or at least periodically in contact with the ground.

The exoskeleton lower end 902j depicted in FIG. 9J is one illustrative example of an exoskeleton lower end of the present disclosure. In other examples, the exoskeleton lower end 902j can include one or more different or additional components compared to those shown in FIG. 9J. In some examples, one or more components illustrated in FIG. 9J may be omitted from the exoskeleton lower end 902j. In some cases, one or more components of another exoskeleton lower end embodiment described herein or illustrated in the figures may be included in the exoskeleton lower end 902j in place of or in addition to one or more components shown in FIG. 9J to form a different embodiment of the exoskeleton lower end 902j. All such exoskeleton lower end embodiment variations are envisioned and included within the scope of the present disclosure.

The exoskeleton lower end 902j is an example alternative embodiment of the exoskeleton lower end 902i described herein and illustrated in FIG. 9I. For instance, the exoskeleton lower end 902j can include the same or similar components, structure, materials, attributes, and functions as that of the exoskeleton lower end 902i. A difference between the exoskeleton lower end 902j and the exoskeleton lower end 902i is that the exoskeleton lower end 902j includes a different actuator end and a different foot attachment interface compared to that of the exoskeleton lower end 902i.

The exoskeleton lower end 902j includes the lower member 944c of an exoskeleton actuator (e.g., the linear actuator 240, not illustrated), the lower juncture assembly 960b, and a foot attachment interface 980j. The foot attachment interface 980j includes a rigid member 982j, the flexible member 984h, and the adjustment component 986h. In the example shown, the rocker bar 962b is coupled at its first end by way of the pivotable juncture 964b to a side or extended portion of the rigid member 982j and further coupled at its second end by way of the pivotable juncture 966b to a location on at least one of the lower member 944c or the actuator end 946c that is proximate or adjacent to a heel region of a user's foot. In this example, the rocker bar 962b extends in a horizontal fore-aft direction (e.g., approximately parallel to the ground) between a heel region and a front region (e.g., ball, forefront, toes) of a user's foot. In one example, the pivotable juncture 964b can be embodied as a ball joint, a pin joint, or a hinge joint. In another example, the pivotable juncture 966b can be embodied as a ball joint or a pin joint. In some embodiments, the lower juncture assembly 960b of the exoskeleton lower end 902j can further include an encoder or a distance sensor positioned at or approximately at location of the pivotable juncture 964b to monitor how at least one of the lower member 944c or the actuator end 946c is raised or lowered relative to a user's foot.

FIG. 9K illustrates a perspective view of another example exoskeleton lower end 902k according to various aspects and embodiments of the present disclosure. The exoskeleton lower end 902k can be designed, embodied, and implemented as a lower portion of a lower body exoskeleton according to different examples described herein. For instance, the exoskeleton lower end 902k can be designed, embodied, and implemented as a lower portion of any exoskeleton embodiment described herein or another exoskeleton. The exoskeleton lower end 902k can be embodied and configured to be at least one of proximate or adjacent to a user's foot, coupled to the user's ankle or foot region, at least partly in contact with the ground, or at least periodically in contact with the ground.

The exoskeleton lower end 902k depicted in FIG. 9K is one illustrative example of an exoskeleton lower end of the present disclosure. In other examples, the exoskeleton lower end 902k can include one or more different or additional components compared to those shown in FIG. 9K. In some examples, one or more components illustrated in FIG. 9K may be omitted from the exoskeleton lower end 902k. In some cases, one or more components of another exoskeleton lower end embodiment described herein or illustrated in the figures may be included in the exoskeleton lower end 902k in place of or in addition to one or more components shown in FIG. 9K to form a different embodiment of the exoskeleton lower end 902k. All such exoskeleton lower end embodiment variations are envisioned and included within the scope of the present disclosure.

The exoskeleton lower end 902k is an example alternative embodiment of the exoskeleton lower end 902h described herein and illustrated in FIG. 9H. For instance, the exoskeleton lower end 902k can include the same or similar components, structure, materials, attributes, and functions as that of the exoskeleton lower end 902h. A difference between the exoskeleton lower end 902k and the exoskeleton lower end 902h is that the exoskeleton lower end 902k includes a different foot attachment interface compared to that of the exoskeleton lower end 902h.

The exoskeleton lower end 902k includes the lower member 944b of an exoskeleton actuator (e.g., the linear actuator 240, not illustrated), the lower juncture assembly 960b, and a foot attachment interface 980k. The foot attachment interface 980k is embodied as a shoe having a portion that is coupled to the first end of the rocker bar 962b by way of the pivotable juncture 964b. In the example shown, the first end of the rocker bar 962b is coupled to at least one of a lower heel or back bottom region of the foot attachment interface 980k (e.g., the shoe) and the second end of the rocker bar 962b is coupled by way of the pivotable juncture 966b to a location on at least one of the lower member 944c or the actuator end 946c that is proximate or adjacent to a front region (e.g., ball, forefront, toes) of a user's foot. In this example, the rocker bar 962b extends in a horizontal fore-aft direction (e.g., approximately parallel to the ground) between a heel region and a front region (e.g., ball, forefront, toes) of a user's foot. In one example, the pivotable juncture 964b can be embodied as a hinge joint. In another example, the pivotable juncture 966b can be embodied as a ball joint or a pin joint.

FIG. 9L illustrates a perspective view of another example exoskeleton lower end 902l according to various aspects and embodiments of the present disclosure. The exoskeleton lower end 902l can be designed, embodied, and implemented as a lower portion of a lower body exoskeleton according to different examples described herein. For instance, the exoskeleton lower end 902l can be designed, embodied, and implemented as a lower portion of any exoskeleton embodiment described herein or another exoskeleton. The exoskeleton lower end 902l can be embodied and configured to be at least one of proximate or adjacent to a user's foot, coupled to the user's ankle or foot region, at least partly in contact with the ground, or at least periodically in contact with the ground.

The exoskeleton lower end 902l depicted in FIG. 9L is one illustrative example of an exoskeleton lower end of the present disclosure. In other examples, the exoskeleton lower end 902l can include one or more different or additional components compared to those shown in FIG. 9L. In some examples, one or more components illustrated in FIG. 9L may be omitted from the exoskeleton lower end 902l. In some cases, one or more components of another exoskeleton lower end embodiment described herein or illustrated in the figures may be included in the exoskeleton lower end 902l in place of or in addition to one or more components shown in FIG. 9L to form a different embodiment of the exoskeleton lower end 902l. All such exoskeleton lower end embodiment variations are envisioned and included within the scope of the present disclosure.

The exoskeleton lower end 902l is an example alternative embodiment of the exoskeleton lower end 902i described herein and illustrated in FIG. 9I. For instance, the exoskeleton lower end 902l can include the same or similar components, structure, materials, attributes, and functions as that of the exoskeleton lower end 902i. A difference between the exoskeleton lower end 902l and the exoskeleton lower end 902i is that the exoskeleton lower end 902l includes a different lower juncture assembly compared to that of the exoskeleton lower end 902i.

The exoskeleton lower end 902l includes the lower member 944c of an exoskeleton actuator (e.g., the linear actuator 240, not illustrated), a lower juncture assembly 960l, and the foot attachment interface 980h. In the example shown, the lower juncture assembly 960l is coupled at a first end to a top portion of the rigid member 982h and further coupled at a second end to a location on the lower member 944c that is proximate or adjacent to the actuator end 946c. In this example, the lower juncture assembly 960l extends in a horizontal or lateral direction (e.g., approximately parallel to the ground) between the rigid member 982h and the lower member 944c. In this example, the lower juncture assembly 960l can be embodied as a flexible beam or as a rigid link with ball joints at each end that allows a user's foot to rotate in three degrees of freedom and translate (e.g., vertically, horizontally) relative to at least one of the lower member 944c or the actuator end 946c.

FIG. 9M illustrates a perspective view of another example exoskeleton lower end 902m according to various aspects and embodiments of the present disclosure. The exoskeleton lower end 902m can be designed, embodied, and implemented as a lower portion of a lower body exoskeleton according to different examples described herein. For instance, the exoskeleton lower end 902m can be designed, embodied, and implemented as a lower portion of any exoskeleton embodiment described herein or another exoskeleton. The exoskeleton lower end 902m can be embodied and configured to be at least one of proximate or adjacent to a user's foot, coupled to the user's ankle or foot region, at least partly in contact with the ground, or at least periodically in contact with the ground.

The exoskeleton lower end 902m depicted in FIG. 9M is one illustrative example of an exoskeleton lower end of the present disclosure. In other examples, the exoskeleton lower end 902m can include one or more different or additional components compared to those shown in FIG. 9M. In some examples, one or more components illustrated in FIG. 9M may be omitted from the exoskeleton lower end 902m. In some cases, one or more components of another exoskeleton lower end embodiment described herein or illustrated in the figures may be included in the exoskeleton lower end 902m in place of or in addition to one or more components shown in FIG. 9M to form a different embodiment of the exoskeleton lower end 902m. All such exoskeleton lower end embodiment variations are envisioned and included within the scope of the present disclosure.

The exoskeleton lower end 902m is an example alternative embodiment of the exoskeleton lower end 902l described herein and illustrated in FIG. 9L. For instance, the exoskeleton lower end 902m can include the same or similar components, structure, materials, attributes, and functions as that of the exoskeleton lower end 902l. A difference between the exoskeleton lower end 902m and the exoskeleton lower end 902l is that the exoskeleton lower end 902m includes a different lower juncture assembly compared to that of the exoskeleton lower end 902l.

The exoskeleton lower end 902m includes the lower member 944c of an exoskeleton actuator (e.g., the linear actuator 240, not illustrated), the lower juncture assembly 960l, a second lower juncture assembly 962l, and the foot attachment interface 980j. In the example shown, the lower member 944c includes a pivotable juncture 948c that is located proximate or adjacent to the actuator end 946c and has an axis of rotation that extends along a longitudinal axis of the lower member 944c. In this example, the lower juncture assembly 960l is coupled at a first end to at least one of a side or top portion of the rigid member 982j and further coupled at a second end to a location on the lower member 944c that is proximate or adjacent to at least one of the pivotable juncture 948c or the actuator end 946c. In this example, the lower juncture assembly 962l is coupled at a first end to at least one of an extended, side, or top portion of the rigid member 982j and further coupled at a second end to a location on the actuator end 946c that is proximate or adjacent to at least one of a side (e.g., outer side) or a front (e.g., ball, forefront, toes) of a user's foot. In this example, each of the lower juncture assemblies 960l, 960m extends in a horizontal or lateral direction (e.g., approximately parallel to the ground) between respective portions of the rigid member 982j, the lower member 944c, and the actuator end 946c. In this example, either or both of the lower juncture assemblies 960l, 960m can be embodied as a flexible beam or as a rigid link with ball joints at each end that allows a user's foot to rotate in three degrees of freedom and translate (e.g., vertically, horizontally) relative to at least one of the lower member 944c or the actuator end 946c.

With reference to FIGS. 9A to 9M collectively, the embodiments illustrated in these figures include several design options for how a lower end of a linear actuator herein can attach to a user's foot through sliding joints or rocker bars. In some cases (e.g., FIGS. 9B, 9H, 9K), the lower end of a linear actuator contacts the ground at a point. These embodiments are relatively simple and allow a linear actuator to achieve a stable fixed resting place on the ground as a gait cycle proceeds. In these embodiments, the force vector may always be at a fixed location with respect to a user's foot.

An alternate approach is to have a curved foot shape at a lower end of a linear actuator (e.g., FIGS. 9A, 9C, 9D, 9F, 9G, 9I, 9J, 9L, 9M). In embodiments having this curved foot shape architecture, such a curved lower end of a linear actuator can contact the ground near a user's heel at heel strike (e.g., 0% in the gait cycle), and then as the gait cycle progresses, the curved shape can roll over the ground, moving the point of force application forward. These embodiments can accurately emulate how the center of pressure in the biological foot moves forward as the gait cycle progresses. Thus, in embodiments with a curved foot shape lower end, the ground reaction forces can duplicate the biological ground reaction force very accurately.

The curved foot shape lower end can be just on the outside of a user's foot in some embodiments, on the inside of a user's foot in other embodiments, or still other embodiments can have two curved foot shape lower ends where one is on the outside of a user's foot and one is on the inside of the user's foot. Having one such curved foot shape lower end on each side of a user's foot as included in some embodiments allows the ground reaction force to be applied under the center of the foot (e.g., in the lateral direction). In many cases, having a linear actuator end contact the ground on the outside of a user's foot will be most useful, since some existing exoskeletons having parts that protrude on the inside of a user's foot can cause the user's foot to run into their opposite foot during locomotion.

In various embodiments illustrated in FIGS. 9A to 9M, a mechanism constraining a lower end of a linear actuator to a user's foot can permit an exoskeleton to move vertically with respect to the user's foot, so that the user's foot can be touching the ground with just the heel or toe or be otherwise inclined or raised relative to the linear actuator. The embodiments also allow a user's foot to have at least some motion in three rotational degrees of freedom (e.g., plantarflexion and/or dorsiflexion, inversion and/or eversion, and abduction and/or adduction) to allow a user's foot to contact the ground even when the user moves their leg through various postures or walks over rough terrain. These embodiments allow a user's foot the ability to rotate in abduction and/or adduction through the entire linear actuator rotating around this axis near the user's hip, so a specific mechanism near a user's ankle may omit this degree of freedom there.

Additionally, the embodiments include a mechanism that can facilitate a lower end of a linear actuator staying near a user's foot as the user's foot translates forward-backward and side-side. For example, during the swing phase of walking, a lower end of a linear actuator in some embodiments can stay in approximately the same location relative to a user's foot (e.g., projected into the horizontal plane) as the user's foot moves to a new location. Thus, embodiments including such a mechanism can be relatively rigid in these directions, although some compliance may be beneficial. The benefit of compliance is largely useful if an exoskeleton's control system mis-estimates when a user is lifting their foot from the ground or touching their foot down to the ground. During normal walking, an exoskeleton control system of some embodiments can lift the exoskeleton lower end or foot (e.g., lower end of an actuator) off the ground at the same time or slightly before a user lifts their foot off the ground, and the exoskeleton control system can plant the exoskeleton lower end or foot on the ground at the same time or just after the user's foot contacts the ground. In other exoskeleton embodiments used for jumping or landing, it is beneficial to have the exoskeleton lower end extend below a user's foot and remain in contact with the ground even if the user's foot is not in contact with the ground. For instance, the exoskeleton lower end can contact the ground before the user's foot during landing and can lift off the ground after the user's foot during jumping. During normal walking, if an exoskeleton controller causes an exoskeleton lower end or foot to contact the ground before a user's foot contacts the ground, the user's foot may still be moving forward even while the exoskeleton lower end or foot is stationary on the ground. As a solution, some embodiments include at least one compliant juncture to provide compliance in the coupling between a user's foot and an exoskeleton lower end that allows a user to continue walking (e.g., moving their foot in the forward-backward direction) without a substantial impact on their gait. Similarly, if an exoskeleton lower end or foot lifts off the ground slightly after a user's foot lifts off the ground, the user may attempt to move their foot forward in swing and may be restricted from doing so by the exoskeleton. As a solution, some embodiments include at least one compliant juncture to provide compliance in the coupling between a user's foot and an exoskeleton lower end or foot that allows this situation to have a reduced impact on the user's gait.

With reference to FIGS. 3 and 4, the exoskeleton lower end of each of the exoskeletons 300, 400 include the positioning member 262 that constrains the lower end (e.g., the inner member 244 and the actuator end 246) of the linear actuator 240. The positioning member 262 permits the lower end of the linear actuator 240 to freely rotate and move up and down relative to the positioning member 262. In some embodiments, limits can be placed on the structure such as hard stops on the lower end (e.g., on the inner member 244 or the actuator end 246) of the linear actuator 240 to prevent the positioning member 262 from coming off the actuator end 246 of the linear actuator 240. The positioning member 262 in some examples is connected to at least one of a foot strap, a shoe, a foot cover, or a user's foot through a ball joint or a compliant juncture or coupling (e.g., a block of rubber) or some combination thereof that allows a user's foot to rotate in three dimensions relative to the positioning member 262. In some examples, such a compliant juncture or coupling can be positioned proximate to the ground, even touching the ground while a user is standing flat-footed, to minimize potential sliding of the actuator end 246 of the linear actuator 240 on the ground if the user lifts their heel or toe. On the user side of such a ball joint or compliant juncture or coupling in some examples, a strap can be used to mount the lower juncture assembly 260 to a user's foot or shoe. The strap can be removable or permanently affixed to a shoe or other foot cover in some cases.

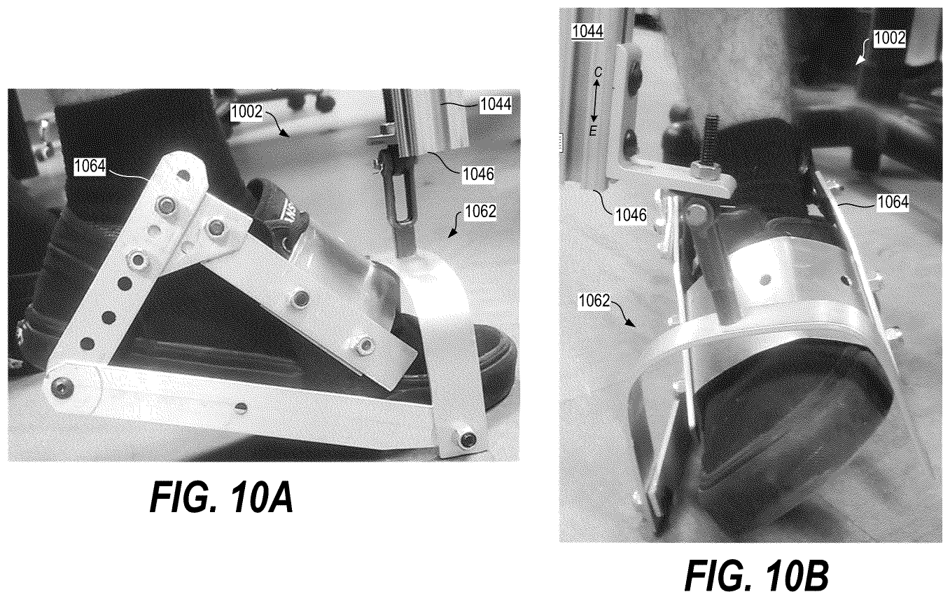

FIG. 10A illustrates a perspective side view of another example exoskeleton lower end 1002 according to various aspects and embodiments of the present disclosure. FIG. 10B illustrates a perspective front view of the example exoskeleton lower end 1002 according to various aspects and embodiments of the present disclosure. The exoskeleton lower end 1002 includes a rocker bar 1062 extending from near a heel of a shoe to a lower end 1046 of a lower member 1044 of a linear actuator (e.g., the linear actuator 240, not illustrated). The exoskeleton lower end 1002, for example, the rocker bar 1062 is configured to contact the ground on both sides of a user's foot, permitting a net load vector that is laterally centered on the user's foot. In order to accommodate rotation of the user's foot in the frontal plane, the exoskeleton lower end 1002 also includes a pivot joint 1064 that is aligned roughly with a user's ankle.

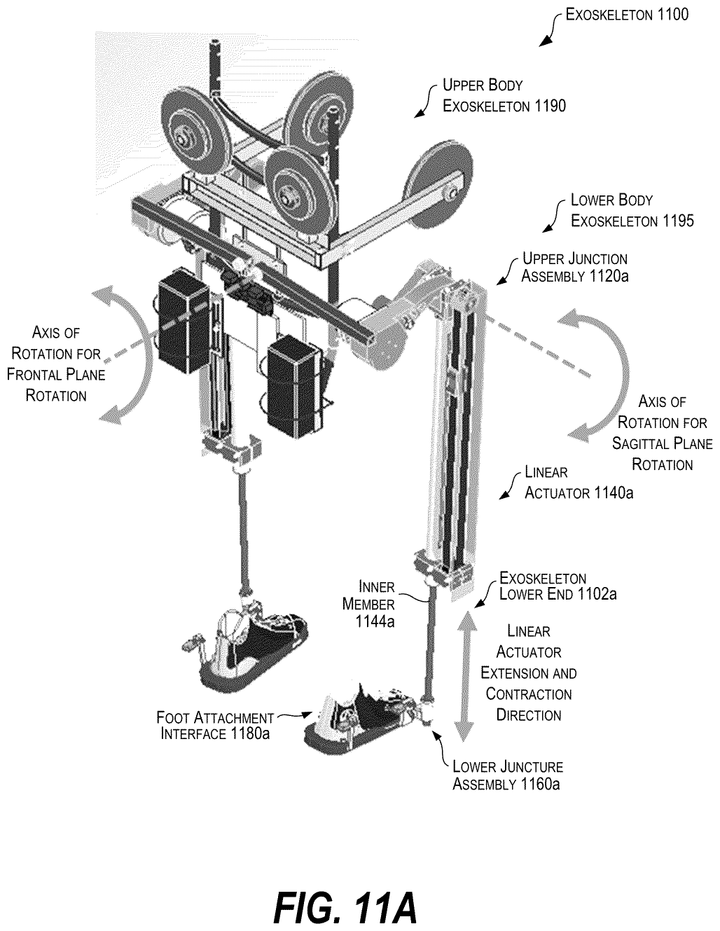

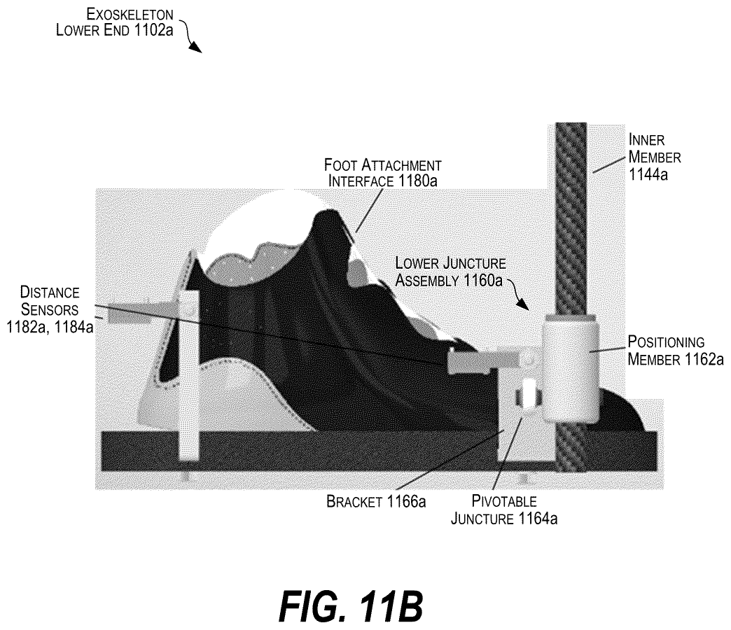

FIG. 11A illustrates a perspective view of another example exoskeleton 1100 according to various aspects and embodiments of the present disclosure. FIG. 11B illustrates a side view of an example exoskeleton lower end 1102a of the example exoskeleton 1100 according to various aspects and embodiments of the present disclosure. The exoskeleton 1100 includes an upper body exoskeleton 1190 and a lower body exoskeleton 1195. The lower body exoskeleton 1195 includes two upper junction assemblies 1120a, 1120b, two linear actuators 1140a, 1140b, two lower junction assemblies 1160a, 1160b, and two foot attachment interfaces 1180a, 1180b, among other components. The linear actuators 1140a, 1140b include an inner member 1144a, 1144b, respectively, and an exoskeleton lower end 1102a, 1102b, respectively. Only a single upper junction assembly 1120, a single linear actuator 1140, a single inner member 1144, a single exoskeleton lower end 1102, a single lower juncture assembly 1160, and a single foot attachment interface 1180 is denoted in FIG. 11A and/or 11B for clarity.

The lower body exoskeleton 1195 can be an example alternative embodiment of any of the exoskeletons 100, 200, 300, 400, 500, 600, 700, 800 described herein and illustrated in FIGS. 1 to 8. For instance, the lower body exoskeleton 1195 can include the same or similar components, structure, materials, attributes, and functions as that of any of the exoskeletons 100, 200, 300, 400, 500, 600, 700, 800. Either or both of the exoskeleton lower ends 1102a, 1102b can be an example alternative embodiment of any of the exoskeleton lower ends 902a, 902b, 902c, 902d, 902e, 902f, 902h, 902i, 902j, 902k, 902l, 902m, 1002 described herein and illustrated in FIGS. 9A to 9M, 10A, and 10B. For instance, either or both of exoskeleton lower ends 1102a, 1102b can include the same or similar components, structure, materials, attributes, and functions as that of any of the exoskeleton lower ends 902a, 902b, 902c, 902d, 902e, 902f, 902h, 902i, 902j, 902k, 902l, 902m, and 1002. Either or both of the upper junction assemblies 1120a, 1120b can be an example alternative embodiment of any of the upper junction assemblies 120, 220, 420, 720, 820 described herein and illustrated in FIGS. 1, 2, 4, 7A, 7B, and 8. For example, either or both of the upper junction assemblies 1120a, 1120b can include the same or similar components, structure, materials, attributes, and functions as that of any of the upper junction assemblies 120, 220, 420, 720, 820. Either or both of the linear actuators 1140a, 1140b can be an example alternative embodiment of either of the linear actuators 140, 240 described herein and illustrated in FIGS. 1 and 2. For example, either or both of the linear actuators 1140a, 1140b can include the same or similar components, structure, materials, attributes, and functions as that of either of the linear actuators 140, 240. Either or both of the inner members 1144a, 1144b can be an example alternative embodiment of either of the inner member 144, 244 described herein and illustrated in FIGS. 1 and 2. For example, either or both of the inner members 1144a, 1144b can include the same or similar components, structure, materials, attributes, and functions as that of either of the inner member 144, 244. Either or both of the lower junction assemblies 1160a, 1160b can be an example alternative embodiment of the lower junction assembly 260 described herein and illustrated in FIG. 2. For example, either or both of the lower junction assemblies 1160a, 1160b can include the same or similar components, structure, materials, attributes, and functions as that of the lower junction assembly 260. Either or both of the foot attachment interfaces 1180a, 1180b can be an example alternative embodiment of the foot attachment interface 280 described herein and illustrated in FIG. 2. For example, either or both of the foot attachment interfaces 1180a, 1180b can include the same or similar components, structure, materials, attributes, and functions as that of the foot attachment interface 280.

With reference to FIGS. 3 and 4, the upper body exoskeleton 1190 and the lower body exoskeleton 1195 are coupled to one another. The linear actuators 1140a, 1140b are respectively coupled to the upper junction assemblies 1120a, 1120b at one end and the inner members 1144a, 1144b are configured to respectively move back and forth inside positioning members 1162a, 1162b of the lower junction assemblies 1160a, 1160b at another end. The lower junction assemblies 1160a, 1160b are respectively coupled to the foot attachment interfaces 1180a, 1180b. For instance, the positioning members 1162a, 1162b are respectively coupled to the foot attachment interfaces 1180a, 1180b by way of pivotable junctures 1164a, 1164b and brackets 1166a, 1166b as illustrated in FIG. 11B. In the example shown, the foot attachment interfaces 1180a, 1180b respectively include distance sensors 1182a, 1184a and distance sensors 1182b, 1184b positioned at locations illustrated in FIG. 11B, for instance, proximate or adjacent to the front of a user's foot and to the heel of the user's foot.

The exoskeleton 1100 can be embodied and configured for carrying heavy loads in, for instance, a backpack. The exoskeleton 1100 can be embodied to include a single connection point configured for connection to a point near the center of a user's back, which is close to the center of mass of the carried load. The connection point to the aforementioned backpack can be moved higher or lower in various examples depending on where the mass is located in the backpack. In embodiments where the upper body exoskeleton 1190 may support loads held in a user's hands, the connection point may be even higher up on the user's body and towards the front of the body instead of at the back of the body. This will allow the upward force to be centered on the mass of the upper body exoskeleton 1190 and the supported load held in the hands. In either the case of the lower body exoskeleton 1195 supporting a load held on a backpack, or the lower body exoskeleton 1195 supporting the upper body exoskeleton 1190, the location where each of the lower ends of the inner members 1144a, 1144b of the linear actuators 1140a, 1140b is situated with respect to the corresponding foot may preferentially be moved forward or backward in different examples so that it lies under the supported center of mass more symmetrically. For example, the lower body exoskeleton 1195 can be centered under a center of mass of a load held on a user's upper body or the upper body exoskeleton 1190 (e.g., with or without a load held in the user's hands), such that when the user is standing straight up, the linear actuators 1140a, 1140b on the lower body exoskeleton 1195 are oriented vertically. To achieve this, the lower end of each of the inner members 1144a, 1144b of the linear actuators 1140a, 1140b can connect near the heel of a user's foot in some examples (e.g., if the center of mass of the upper body load is located near the user's back) or near the ball or toe of the user's foot in other examples (e.g., if the center of mass of the upper body is located near the front of the user's body). In either case, the user's foot can move up and down with respect to its corresponding inner member 1144a, 1144b of its corresponding linear actuator 1140a, 1140b. This will allow each linear actuator 1140a, 1140b to contact the ground even if the user's corresponding foot is not flat on the ground.

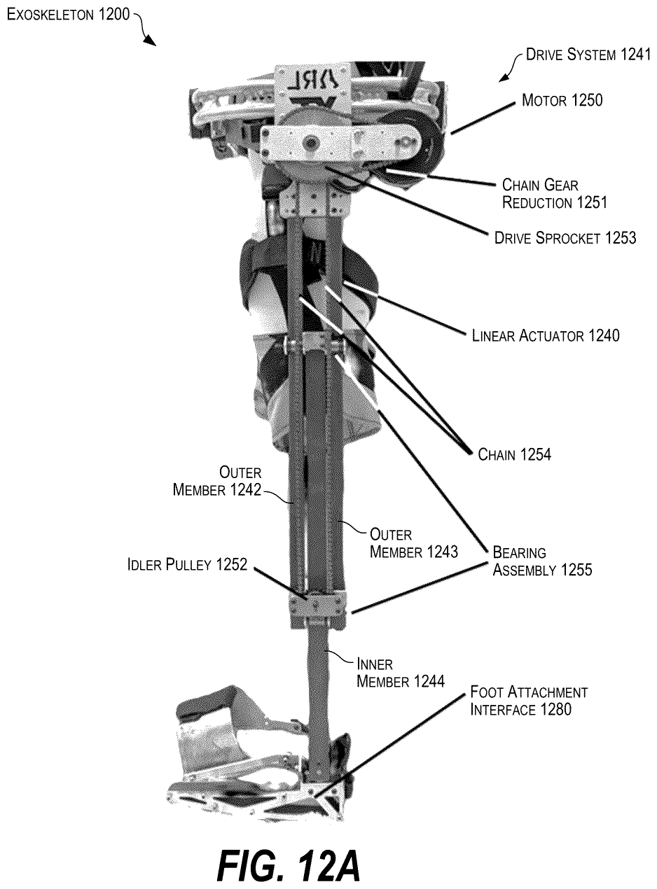

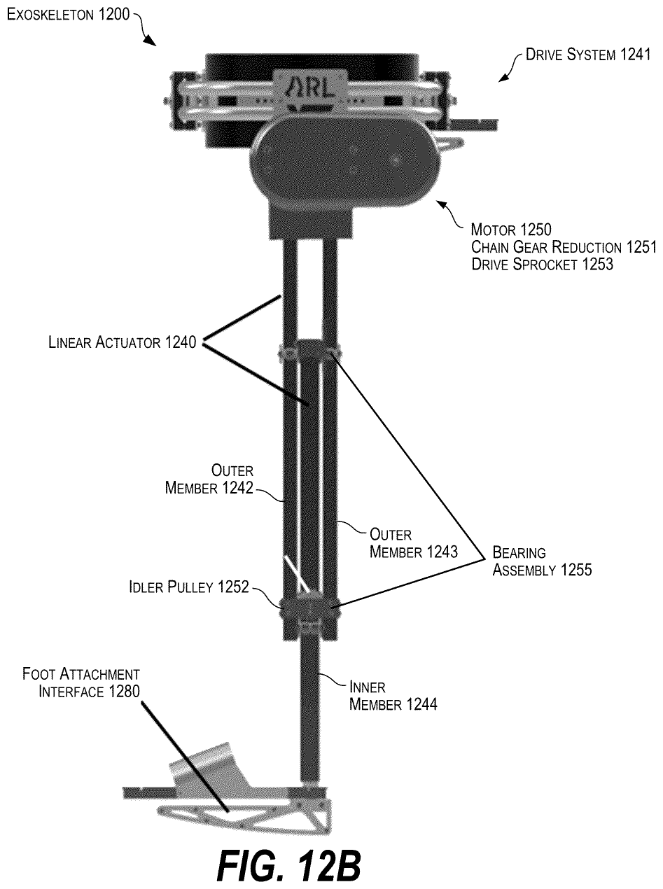

FIG. 12A illustrates a side view of another example exoskeleton 1200 according to various aspects and embodiments of the present disclosure. FIG. 12B illustrates another side view of the example exoskeleton of FIG. 12A with covers included according to various aspects and embodiments of the present disclosure. The exoskeleton 1200 can be designed, embodied, and implemented as a lower body exoskeleton according to different examples described herein. The exoskeleton 1200 depicted in FIGS. 12A and 12B is one illustrative example of an exoskeleton of the present disclosure. In other examples, the exoskeleton 1200 can include one or more different or additional components compared to those shown in FIGS. 12A and 12B. In some examples, one or more components illustrated in FIG. 12A or 12B may be omitted from the exoskeleton 1200. In some cases, one or more components of another exoskeleton embodiment described herein or illustrated in the figures may be included in the exoskeleton 1200 in place of or in addition to one or more components shown in FIGS. 12A and 12B to form a different embodiment of the exoskeleton 1200. All such exoskeleton embodiment variations are envisioned and included within the scope of the present disclosure.

The exoskeleton 1200 can be an example alternative embodiment of any of the exoskeletons 100, 200, 300, 400, 500, 600, 700, 800 described herein and illustrated in FIGS. 1 to 8. For instance, the exoskeleton 1200 can include the same or similar components, structure, materials, attributes, and functions as that of any of the exoskeletons 100, 200, 300, 400, 500, 600, 700, 800. A difference between the exoskeleton 1200 and the exoskeletons 100, 200, 300, 400, 500, 600, 700, 800 is that the exoskeleton 1200 includes a different linear actuator and a different actuator drive system compared to that of each of the exoskeletons 100, 200, 300, 400, 500, 600, 700, 800.

The exoskeleton 1200 includes at least one linear actuator 1240, among other components. Only a single linear actuator 1240 and components thereof are illustrated and/or denoted in FIGS. 12A and 12B for clarity. In some embodiments, the exoskeleton 1200 may include at least one of a different user harness interface, a different upper juncture assembly, a different and/or additional linear actuator, a different and/or additional lower juncture assembly, or a different and/or additional foot attachment interface compared to what is illustrated in FIGS. 12A and 12B. The linear actuator 1240 can be an example alternative embodiment of either of the linear actuators 140, 240 described herein and illustrated in FIGS. 1 and 2. For example, the linear actuator 1240 can include the same or similar components, structure, materials, attributes, and functions as that of either of the linear actuators 140, 240.

The linear actuator 1240 includes a drive system 1241, a first outer member 1242, a second outer member 1243, and an inner member 1244. The drive system 1241 is embodied and configured as a chain drive that includes a motor 1250 and a first stage of the drive system 1241, for instance, a chain gear reduction 1251 that increases torque and slows down speed. The output of that stage (e.g., output of the chain gear reduction 1251) is embodied as a drive sprocket 1253 which is the input to a second stage of the drive system 1241 that extends down the linear actuator 1240. The second stage of the drive system 1241 includes an idler pulley 1252, the drive sprocket 1253, a chain 1254, and a bearing assembly 1255. At the bottom of the second stage is the idler pulley 1252 (e.g., idler sprocket) so the chain 1254 forms a closed loop. The lower half of the linear actuator 1240, for instance, the inner member 1244 is connected to the chain 1254 at its top (e.g., at the top of the inner member 1244 by way of the bearing assembly 1255). To operate, the drive sprocket 1253 turns, which causes the chain 1254 to rotate around in a loop. This in turn pushes the inner member 1244 of the linear actuator 1240 down or pulls it up.

In the example shown, the outer members 1242, 1243 and the inner member 1244 are embodied and configured such that the inner member 1244 is positioned parallel to and at least partly between the outer members 1242, 1243. In one example, each of the outer members 1242, 1243 can include an aluminum or aluminum alloy material, although another material may be used in some cases. In another example, the inner member 1244 can include a carbon fiber material or aluminum material, although other materials may be used in some cases. The inner member 1244 travels between the outer members 1242, 1243. The outer members 1242, 1243 and the inner member 1244 are configured such that the inner member 1244 slides between the outer members 1242, 1243 during contraction and extension of the inner member 1244 when one or more linear forces are applied to at least one of the outer members 1242, 1243 or the inner member 1244 by the drive system 1241 of the linear actuator 1240.

In the example shown, the linear actuator 1240 includes a frame with three members (e.g., tubes), the outer member 1242, the outer member 1243, and the inner member 1244. The outer members 1242, 1243 in parallel form an upper half of such a frame of the linear actuator 1240, while the inner member 1244 slides up and down relative to the outer members 1242, 1243 to form a lower half of the linear actuator 1240. The bearing assembly 1255 couples such an upper and lower half of the linear actuator 1240 so that the two halves move relative to each other with low friction. The bearing assembly 1255 can be embodied as or include, for instance, bushings, roller bearings, or any another type of bearing or bearing-type mechanism.

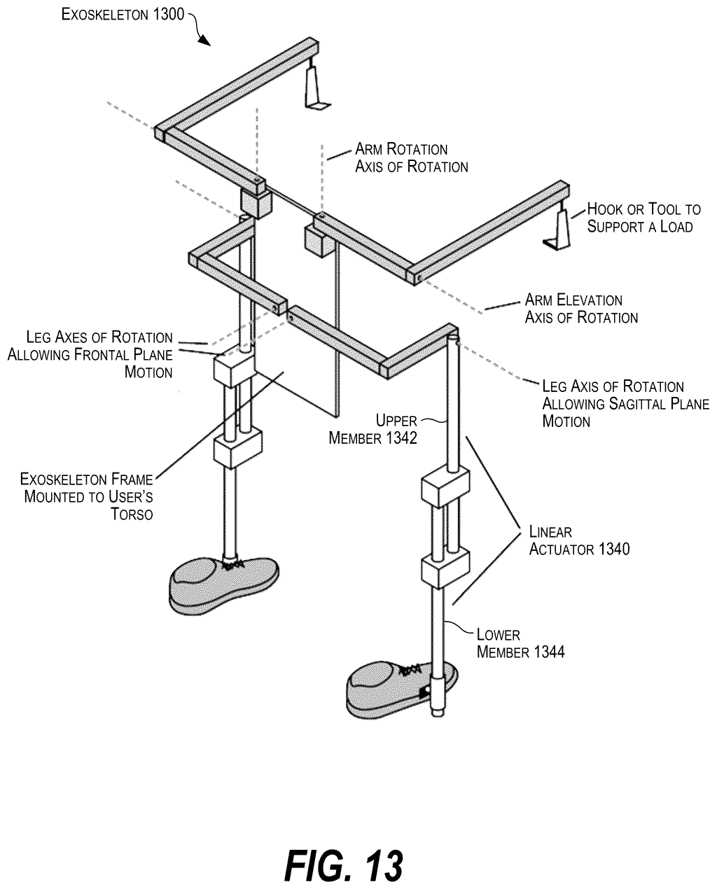

FIG. 13 illustrates a perspective view of another example exoskeleton 1300 according to various aspects and embodiments of the present disclosure. The exoskeleton 1300 can be designed, embodied, and implemented as a lower body exoskeleton according to different examples described herein. The exoskeleton 1300 depicted in FIG. 13 is one illustrative example of an exoskeleton of the present disclosure. In other examples, the exoskeleton 1300 can include one or more different or additional components compared to those shown in FIG. 13. In some examples, one or more components illustrated in FIG. 13 may be omitted from the exoskeleton 1300. In some cases, one or more components of another exoskeleton embodiment described herein or illustrated in the figures may be included in the exoskeleton 1300 in place of or in addition to one or more components shown in FIG. 13 to form a different embodiment of the exoskeleton 1300. All such exoskeleton embodiment variations are envisioned and included within the scope of the present disclosure.

The exoskeleton 1300 can be an example alternative embodiment of any of the exoskeletons 100, 200, 300, 400, 500, 600, 700, 800 described herein and illustrated in FIGS. 1 to 8. For instance, the exoskeleton 1300 can include the same or similar components, structure, materials, attributes, and functions as that of any of the exoskeletons 100, 200, 300, 400, 500, 600, 700, 800. A difference between the exoskeleton 1300 and the exoskeletons 100, 200, 300, 400, 500, 600, 700, 800 is that the exoskeleton 1300 includes a different linear actuator compared to that of each of the exoskeletons 100, 200, 300, 400, 500, 600, 700, 800.

The exoskeleton 1300 includes at least one linear actuator 1340, among other components. Only a single linear actuator 1340 and components thereof are denoted in FIG. 13 for clarity. In some embodiments, the exoskeleton 1300 may include at least one of a different user harness interface, a different upper juncture assembly, a different and/or additional linear actuator, a different and/or additional lower juncture assembly, or a different and/or additional foot attachment interface compared to what is illustrated in FIG. 13. The linear actuator 1340 can be an example alternative embodiment of either of the linear actuators 140, 240 described herein and illustrated in FIGS. 1 and 2. For example, the linear actuator 1340 can include the same or similar components, structure, materials, attributes, and functions as that of either of the linear actuators 140, 240.

The linear actuator 1340 includes an upper member 1342 and a lower member 1344. In the example shown, the upper member 1342 and the lower member 1344 are embodied and configured such that they are parallel to one another. In one example, the upper member 1342 can include an aluminum or aluminum alloy material, although another material may be used in some cases. In another example, the lower member 1344 can include a carbon fiber material or aluminum material, although other materials may be used in some cases. The lower member 1344 travels next to the upper member 1342. The lower member 1344 and the upper member 1342 are configured such that the lower member 1344 slides adjacent to and alongside the upper member 1342 during contraction and extension of the lower member 1344 when one or more linear forces are applied to at least one of the upper member 1342 or the lower member 1344 by the linear actuator 1340. In the example shown, the linear actuator 1340 includes a frame with two members (e.g., tubes), the upper member 1342 and the lower member 1344. The upper member 1342 forms an upper half of such a frame of the linear actuator 1340, while the lower member 1344 slides up and down relative to the upper member 1342 to form a lower half of the linear actuator 1340.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.” As referenced herein, the term “user” refers to at least one of a human, an end-user, a consumer, a computing device and/or program (e.g., a processor, computing hardware and/or software, an application), an agent, a machine learning (ML) model and/or an artificial intelligence (AI) model, and/or another type of user that can implement and/or facilitate implementation of one or more embodiments of the present disclosure as described herein, illustrated in the accompanying drawings, and/or included in the appended claims. As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. An exoskeleton, comprising:
an upper juncture assembly for positioning at least partly around a waist of a user;
a linear actuator having a first end and a second end opposite the first end, the first end of the linear actuator being coupled to the upper juncture assembly;
a lower juncture assembly coupled to the second end of the linear actuator, the lower juncture assembly configured for positioning the second end of the linear actuator at a side of a foot of the user; and
a foot attachment interface for positioning at least partly around the foot of the user.

2. The exoskeleton of claim 1, wherein the lower juncture assembly is configured to permit at least one degree of freedom between the linear actuator and the foot of the user during a gait cycle of the user.

3. The exoskeleton of claim 1, wherein the lower juncture assembly comprises at least one of a compliant juncture, a flexible beam, a pivotable juncture, a ball joint, a pin joint, or a hinge joint between the foot attachment interface and the linear actuator.

4. The exoskeleton of claim 1, wherein:
the lower juncture assembly comprises a pivotable juncture and a positioning tube;
the pivotable juncture is coupled to the foot attachment interface and the positioning tube; and
the linear actuator extends through the positioning tube.

5. The exoskeleton of claim 1, wherein the lower juncture assembly comprises a rocker bar, a first pivotable juncture between the rocker bar and the foot attachment interface, and a second pivotable juncture between the rocker bar and the linear actuator.

6. The exoskeleton of claim 5, wherein at least one of the first pivotable juncture or the second pivotable juncture comprises a ball joint, a pin joint, or a hinge joint.

7. The exoskeleton of claim 1, further comprising a ground contact platform at the second end of the linear actuator.

8. The exoskeleton of claim 1, wherein the foot attachment interface comprises a foot strap, a foot cover, an ankle harness interface, an ankle strap, or a shoe and a brace secured to or within the shoe, the brace being coupled to the lower juncture assembly.

9. The exoskeleton of claim 1, wherein the linear actuator comprises at least one of a motor or a clutch located between the first end and the second end of the linear actuator.

10. The exoskeleton of claim 1, further comprising at least one of an inertial measurement unit or a distance sensor positioned to measure a distance from at least one of the foot attachment interface or the linear actuator to a ground surface.

11. The exoskeleton of claim 1, further comprising:
a user harness interface for positioning at least partly around the waist of the user,
wherein the upper juncture assembly comprises a brace, a first pivotable juncture between the brace and the linear actuator, and a second pivotable juncture between the brace and the user harness interface.

12. The exoskeleton of claim 1, further comprising:
a user harness interface for positioning at least partly around the waist of the user,
wherein the upper juncture assembly comprises a brace extending from a front side of the user harness interface to a back side of the user harness interface, a first pivotable juncture between the brace and the linear actuator, and a second pivotable juncture between the brace and the user harness interface.

13. The exoskeleton of claim 1, further comprising:
a user harness interface for positioning at least partly around the waist of the user,
wherein the upper juncture assembly comprises a brace extending from a front side of the user harness interface to a back side of the user harness interface, a first pivotable juncture between one end of the brace and a front side of the user harness interface, a second pivotable juncture between another end of the brace and a back side of the user harness interface, and a third pivotable juncture between the brace and the linear actuator.

14. An exoskeleton, comprising:
an upper juncture assembly for positioning at least partly around a waist of a user;
a linear actuator having a first end and a second end opposite the first end, the first end of the linear actuator being coupled to the upper juncture assembly and the second end of the linear actuator comprising a ground contact platform;
a lower juncture assembly coupled to the second end of the linear actuator, the lower juncture assembly configured for positioning the ground contact platform of the linear actuator below a foot of the user; and
a foot attachment interface for positioning at least partly around an ankle region of the foot of the user.

15. The exoskeleton of claim 14, wherein the lower juncture assembly comprises at least one of a compliant juncture, a flexible beam, a pivotable juncture, a ball joint, a pin joint, or a hinge joint between the foot attachment interface and the linear actuator.

16. The exoskeleton of claim 14, wherein:
the lower juncture assembly comprises a pivotable juncture and a positioning tube;
the pivotable juncture is coupled to the foot attachment interface and the positioning tube; and
the linear actuator extends through the positioning tube.

17. The exoskeleton of claim 14, wherein the lower juncture assembly comprises a rocker bar, a first pivotable juncture between the rocker bar and the foot attachment interface, and a second pivotable juncture between the rocker bar and the linear actuator.

18. The exoskeleton of claim 17, wherein:
at least one of the first pivotable juncture or the second pivotable juncture comprises a ball joint, a pin joint, or a hinge joint; and
the foot attachment interface comprises an ankle harness interface or an ankle strap.

19. An exoskeleton, comprising:
an upper exoskeleton; and
a lower exoskeleton coupled to the upper exoskeleton, the lower exoskeleton comprising:
an upper juncture assembly coupled to the upper exoskeleton and configured for positioning at least partly around a waist of a user;
a linear actuator having a first end and a second end opposite the first end, the first end of the linear actuator being coupled to the upper juncture assembly;
a lower juncture assembly coupled to the second end of the linear actuator, the lower juncture assembly configured for positioning the second end of the linear actuator at a side of or below a foot of the user; and
a foot attachment interface for positioning at least partly around the foot of the user or an ankle region of the foot of the user.

20. The exoskeleton of claim 19, wherein the lower exoskeleton further comprises:
a second upper juncture assembly coupled to the upper exoskeleton and configured for positioning at least partly around the waist of the user;
a second linear actuator having a first end and a second end opposite the first end, the first end of the second linear actuator being coupled to the second upper juncture assembly;
a second lower juncture assembly coupled to the second end of the second linear actuator, the second lower juncture assembly configured for positioning the second end of the second linear actuator at a side of or below a second foot of the user; and
a second foot attachment interface for positioning at least partly around the second foot of the user or an ankle region of the second foot of the user.
